(19) United States
(12) Patent Application Publication
(10) Pub. No.: US 2026/0242093 A1
(43) Pub. Date: Aug. 20, 2026

(54) SINGLE USE CONTAINER HAVING AN ALIGNMENT FEATURE FOR EFFICIENT RECYCLING

(71) Applicant: Cambio Roasters, LLC, Isle of Palms, SC (US)

(72) Inventors: Richard Estabrook, Shelburne, VT (US); Kevin Hartley, Isle of Palms, SC (US); Michael Cunningham, Newport, RI (US); Peter George Gosselin, Richmond, VT (US); Leo Halgas Gosselin, Richmond, VT (US)

(73) Assignee: Cambio Roasters, LLC, Isle of Palms, SC (US)

(21) Appl. No.: 19/542,992

(22) Filed: Feb. 18, 2026

Related U.S. Application Data
(60) Provisional application No. 63/759,874, filed on Feb. 18, 2025.

(51) Int. Cl. B65D 21/02; B29C 64/386; B33Y 50/00; B33Y 80/00; B65D 1/26; B65D 25/34; B29L 31/00

(52) U.S. Cl. CPC B65D 21/0233; B29C 64/386; B33Y 50/00; B33Y 80/00; B65D 1/265; B65D 25/34; B29L 2031/712

(57) ABSTRACT

A single use container includes a container body. The container body includes an open end, a closed end, a body wall between the open end and the closed end, and at least an end lock feature. The at least an end lock feature is disposed at or adjacent one of the open end and closed end. The at least an end lock feature is configured to lock the single use container into a second container by engaging with a corresponding feature on the second container.

### CROSS-REFERENCE TO RELATED APPLICATIONS

This application claims the benefit of priority of U.S. Provisional Patent Application Serial No. 63/759,874, filed on February 18, 2025, and titled “SINGLE USE CONTAINER HAVING AN ALIGNMENT FEATURE FOR EFFICIENT RECYCLING,” which is incorporated by reference herein in its entirety.

### FIELD OF THE INVENTION

The present invention generally relates to the field of recycling. In particular, the present invention is directed to an apparatus with nesting and locking features designed to enhance the efficiency of recycling processes.

### BACKGROUND

Containers without nesting and locking features pose significant challenges for recycling processes. When containers cannot be efficiently stacked or secured, they create disorganization in storage and transportation, making it harder for recycling facilities to sort materials effectively. This lack of structure complicates the sorting process, leading to delays and inefficiencies that hinder the overall success of recycling operations.

### SUMMARY OF THE DISCLOSURE

In an aspect, a single use container includes a container body; the container body includes an open end, a closed end, a body wall between the open end and the closed end, and at least an end lock feature disposed at or adjacent one of the open end and the closed end, wherein the end lock feature is configured to lock the single use container into a second container by engaging with a corresponding feature on the second container.

In another aspect, a single use container includes a container body; the container body includes an open end, a closed end, a body wall between the open end and the closed end, and at least a rotational engagement mechanism disposed at or adjacent the open end, wherein the at least a rotational engagement mechanism includes an open configuration and a closed configuration, wherein the rotational engagement mechanism is configured to lock the single use container into a second container by engaging with a corresponding feature on the second container when the rotational engagement mechanism is rotated into the closed configuration.

In another aspect, a single use container includes a container body, wherein the container body includes an open end, a closed end, a body wall between the open end and the closed end, and at least a rotational engagement mechanism disposed at or adjacent the open end, wherein the at least a rotational engagement mechanism includes an open configuration and a closed configuration, wherein the rotational engagement mechanism is configured to lock the single use container into a second container by engaging with a corresponding feature on the second container when the rotational engagement mechanism is rotated into the closed configuration.

In another aspect, a method of manufacturing a single use container includes fabricating the single use container by a printing process, wherein fabricating the single use container includes generating, using at least a processor, a digital model of the single use container; providing, using the at least a processor, the digital model to a three-dimensional (3D) printing apparatus; and layering, using the 3D printing apparatus, printing material in accordance with the digital model.

In another aspect, a method of manufacturing a single use container includes fabricating the single use container using a molding process, wherein fabricating the single use container includes providing a mold that defines a container body having an open end, a closed end, and a body wall between the open end and the closed end, and at least a lock feature configured to lock the single use container into a second container by engaging with a corresponding feature on the second container; and introducing a molding material into the mold to form the single use container in accordance with the mold configuration.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is an exemplary illustration of a side view of two containers with top lock features;

FIG. 1B is an exemplary illustration of a cross sectional view of two containers with top lock features, wherein the two containers are stacked in an unlocked position;

FIG. 1C is an exemplary illustration of a cross sectional view of two containers with top lock features, wherein the two containers are stacked in a locked position;

FIG. 2A is an exemplary illustration of a side view of two containers with bottom lock features;

FIG. 2B is an exemplary illustration of a cross sectional view of two containers with bottom lock features, wherein the two containers are stacked in an unlocked position;

FIG. 2C is an exemplary illustration of a cross sectional view of two containers with bottom lock features, wherein the two containers are stacked in a locked position;

FIG. 3A is an exemplary illustration of a cross section view of two containers with bayonet lock features, wherein the two containers are in an unlocked position;

FIG. 3B is an exemplary illustration of a top isometric view of a container with a bayonet lock feature;

FIG. 3C is an exemplary illustration of a side view of two containers with bayonet lock features, wherein the two containers are in a locked position;

FIGS. 4A-B are cross-sectional views of exemplary embodiments of a single use container;

FIGS. 5A-E are diagrams illustrating exemplary embodiments of alignment features;

FIG. 6 is a diagram shows an exemplary embodiment of a plurality of interlocked single use containers;

FIG. 7 is a block diagram of an exemplary method of fabricating, using a 3D printing apparatus, the single use container;

FIG. 8 is a block diagram of an exemplary method of fabricating the single-use container using a molding process;

FIG. 9 is an exemplary embodiment of a beverage pod;

FIG. 10 is a nonlimiting particular embodiment of a peelable lid with a frangible seal;

FIG. 11 is a particular embodiment of a container body;

FIGS. 12A-B are particular embodiments and placement of adhesives and/or polymer layers;

FIG. 13 is a particular embodiment of a pull tab;

FIG. 14 a side view of an exemplary embodiment of multi-layer sheet;

FIG. 15 is a nonlimiting particular embodiment of a container with a dual-layer lid structure; and

FIG. 16 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to a single use container having an alignment feature for efficient recycling. Aspects of the present disclose can be used to securely combine multiple single use containers to form a larger container big enough to pass through size-sortation technologies in Municipal Recycling Centers. This is so, at least in part, because single use container may have tapered sidewalls or straight sidewalls having interlocking features configured to enable a plurality of single use containers to “lock” together. In some cases, interlocking features may be easily completed by consumers. Exemplary embodiments illustrating aspects of the present disclosure are described below in the context of several specific examples.

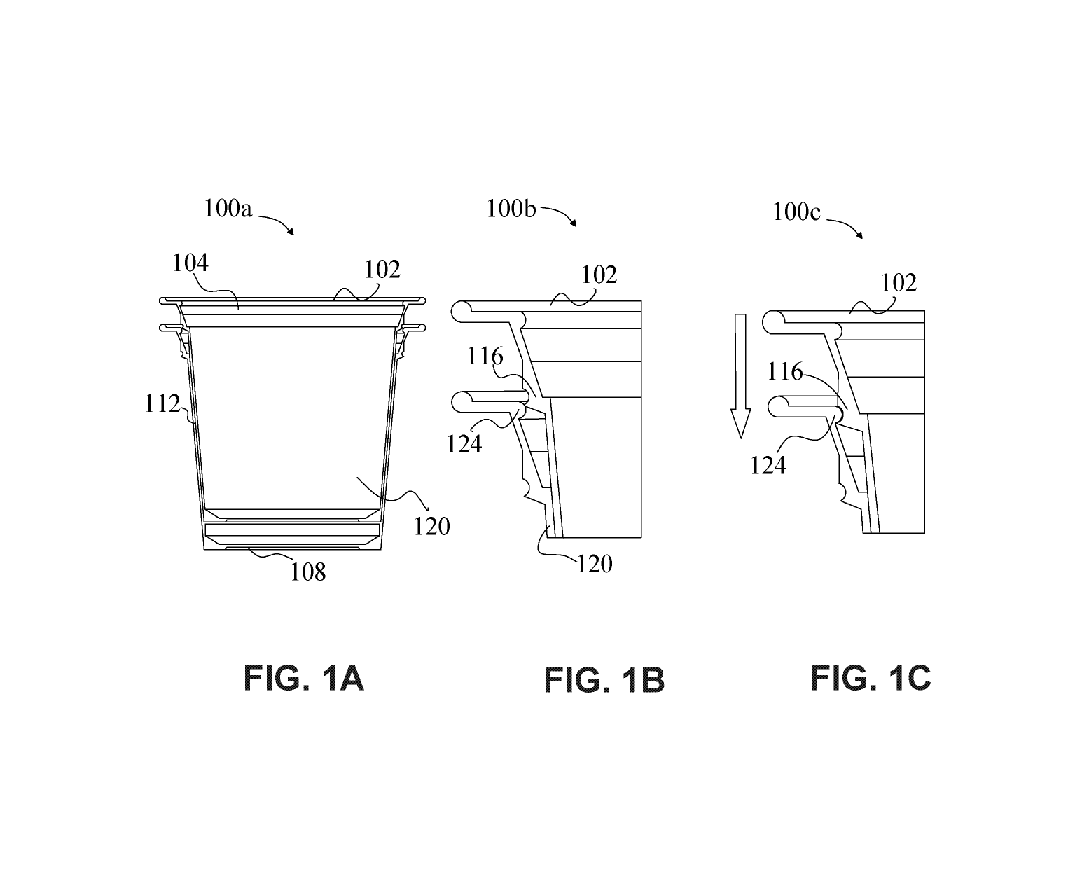

Now referring to FIG. 1A, an exemplary illustration 100a of a side view of two containers with top lock features. Single use container 102 includes a container body, wherein the container body includes an open end 104, a closed end 108, a body wall 112 between open end 104 and closed end 108, and at least an end lock feature 116 disposed at or adjacent one of open end 104 and closed end 108, wherein the end lock feature is configured to lock the single use container 102 into a second container 120 by engaging with a corresponding feature 124 on second container 120. At least an end lock feature 116 may include a top lock feature or a bottom lock feature. As used in this disclosure, a "container" is a structure or device designed to hold, store, or transport one or more items, substances, or materials. A “single use container,” as used herein, is a container or cartridge that is designed to be used only once and then disposed of or discarded. In a non-limiting example, a single use container may include coffee pods, such as K-CUP pods or NESPRESSO capsules. Container 102 may include an interior cavity, walls, and an opening that can be selectively sealed or accessed. Container 102 may be made of various materials, including but not limited to plastic, metal, glass, composites, and the like, and may be configured for specific applications such as storage, shipping, or organization. As used in this disclosure, a "container body" is a structural component of container that defines its primary shape and provides an enclosed or semi-enclosed space for holding, storing, or transporting contents. The container body typically includes an open end 104, a closed end 108, and a body wall 112 extending between the open and closed end 108. In an embodiment, container body may be configured with additional features such as alignment components, lock mechanisms, or surface treatments to facilitate specific functions or interactions with other components. An “open end,” for the purpose of this disclosure, refers to a portion of container body that allows access to the interior of container body. Open end 104 may be configured to allow the insertion or removal of contents, the introduction of materials such as fluids or solids, or interaction with additional components such as covers, seals, or closures. Open end 104 may include features such as threads, flanges, or other engagement mechanisms to facilitate sealing or attachment. As used in this disclosure, a “closed end” is the opposite end of container body from open end 104. Without limitation, the closed end 108 may include features such as reinforcement structures, flow-directing components, or surfaces designed to interact with external devices or systems. The closed end 108 ensures that the contents of container 102 are retained and provides structural integrity to the container body. As used in this disclosure, a "body wall" is a portion of container body that extends between open end 104 and closed end 108. In one or more embodiments, body wall 112 may be a cylindrical portion. In an embodiment, body wall 112 may include features such as ribs, grooves, alignment components, or surface treatments to enhance the structural integrity, functionality, or compatibility of container 102 with other components or systems. As used in this disclosure, a "lock feature" is a mechanism or element incorporated into a device or structure to restrict or control access to an interior space, component, or functionality. The lock feature may include mechanical, electronic, or magnetic components and may operate using keys, codes, biometrics, or other actuation methods. The lock feature may be designed to enhance security, prevent unauthorized access, or maintain the integrity of the contents or operation of the associated device or structure. In an embodiment, lock feature may include structural elements such as tabs, ridges, threads, interlocking surfaces, other engagement mechanisms, and the like, that interact with a corresponding feature 124 on second container 120. The lock feature may be designed to provide a secure connection, facilitate alignment, prevent unintentional disassembly, or ensure a fluid-tight or airtight seal between the two components. As used in this disclosure, a "top lock feature" is a locking mechanism located at or near open end of a container body, configured to engage with a corresponding feature on a second container or component. The top lock feature may include structural elements such as tabs, ridges, threads, or interlocking surfaces designed to securely connect, align, or stabilize the two containers when stacked or joined. “End lock feature,” as used in this disclosure, is a structural element disposed at or adjacent an open end or a closed end of a container body. In one or more embodiments, at least an end lock feature 116 may include structural element being configured to mechanically engage with a corresponding feature on a second container 120 to create a releasable locking connection between a container body and a second container 120. “Corresponding feature,” as used in this disclosure, is a complementary structural element formed on a second container. In one or more embodiments, corresponding feature 124 may include complementary structural element being configured to receive, align with, and mechanically engage at least an end lock feature 116 of a first container to establish a releasable locking connection between the first container and second container 120. In one or more embodiments, corresponding feature 124 may include a recessed groove formed in a body wall of second container 120, wherein recessed groove is dimensioned to receive a protruding ridge of at least an end lock feature 116. In one or more embodiments, corresponding feature 124 may include an inwardly extending flange disposed at or adjacent an open end of second container 120, wherein the inwardly extending flange is configured to engage an outwardly extending lip of at least an end lock feature 116. In one or more embodiments, corresponding feature 124 may include a bayonet slot having at least one axial entry channel and at least one circumferential locking channel configured to receive a bayonet projection of at least an end lock feature 116 and retain the bayonet projection upon rotational movement. In one or more embodiments, corresponding feature 124 may include a detent recess configured to receive a resilient tab or spring-biased protrusion of at least an end lock feature 116. In one or more embodiments, corresponding feature 124 may include a threaded region formed on an inner surface of second container 120 and configured to engage a complementary threaded region formed on at least an end lock feature 116.

With continued reference to FIG. 1A, container body may be constructed from a metal material. Metal material is a metallic substance that can be used for a single-use container body. In one or more embodiments, metal material may be selected to provide structural rigidity, barrier performance, manufacturability, and regulatory compliance for a single-use container body. Metal material may include, without limitation, aluminum, stainless steel, or other alloys selected based on their lightweight properties, corrosion resistance, and compatibility with the intended use of container 102. In an embodiment, metal construction may facilitate precision forming processes, such as stamping, deep drawing, extrusion, and the like to create the container body with the desired dimensions, thickness, and features. Metal material may enable the incorporation of specialized surface finishes, such as anodizing, coating, or polishing, to improve the aesthetic appearance, reduce friction, or enhance the barrier properties of container 102. Additionally and/or alternatively, the use of a metal material for the container body may allow for better thermal conductivity, making container 102 suitable for applications involving temperature-sensitive materials or processes. Metal material may also be selected to meet specific regulatory or industry standards for safety, hygiene, or recyclability. In one or more embodiments, metal material may be selected from aluminum or aluminum-based alloys. In one or more embodiments, metal material may include coated or clad metals, including aluminum-polymer laminates or corrosion-resistant alloy systems. In one or more embodiments, metal material may exhibit sufficient ductility and elongation to permit deep drawing without fracture, wrinkling, or excessive thinning of a body wall 112 during forming. In some embodiments, surface treatments may improve adhesion between metal material and subsequently applied coatings, sealants, or lid-sealing interfaces. In one or more embodiments, thermal conductivity of metal material may promote more uniform heat transfer during brewing, sealing, or sterilization operations.

With continued reference to FIG. 1A, the container body may include a coating material applied to body wall 112. Without limitation, the coating material may enhance body wall 112 performance, durability, and/or functionality. The coating material may serve various purposes, such as providing a protective barrier against corrosion, abrasion, or chemical reactions, particularly when container 102 is exposed to moisture, acids, or other reactive substances. In an embodiment, the coating material may be a polymer-based layer, such as a food-grade epoxy resin or polyethylene, to ensure compatibility with consumable substances or sensitive materials. Additionally and/or alternatively, the coating material may include metallic layers, such as tin or chromium, applied through processes like electroplating or vapor deposition to improve the surface properties of body wall 112. The coating material may enhance the aesthetic of container 102 by providing a uniform finish, color, or texture. For instance, the coating may include pigments or dyes for branding purposes or UV-resistant compounds to prevent discoloration over time. In another embodiment, the coating material may be designed to improve functional properties such as thermal insulation, electrical conductivity, or resistance to specific environmental conditions. The application of the coating material may be achieved through various techniques, including spraying, dipping, rolling, or curing, depending on the material properties and the manufacturing process.

With continued reference to FIG. 1A, the at least a top lock feature may include an interference-fit mechanism configured to align with a receiving port on the second container 120 and lock with the receiving port on second container 120. In an embodiment, container 102 may be designed to be stackable such that the dimensions of the containers allow them to fit snugly inside each other. Continuing, the top lock feature may be designed so that the force of gravity alone is insufficient to engage or "activate" the lock. Without limitation, additional force, applied manually by the user, may be required to fully engage the top lock feature and secure containers together. Continuing, this may ensure that containers remain separate and do not inadvertently lock when simply stacked. As used in this disclosure, an "interference-fit mechanism" is a type of fastening system in which two components are joined together by dimensional interference. In one or more embodiments, interference-fit mechanism may include dimensions of one component are slightly larger than corresponding dimensions of mating component. Without limitation, the interference-fit mechanism may create a secure connection through friction, compression, or both, without the need for additional fasteners, adhesives, or tools. Without limitation, the interference-fit mechanism may be designed to provide a tight and stable engagement, ensuring that the components remain securely connected under normal operating conditions. In an embodiment, the interference-fit mechanism may include features such as ridges, grooves, or surface textures to enhance the frictional force between the components. Continuing, the interference-fit mechanism may be used in various applications, such as securing a lock feature on a container 102 to a corresponding feature 124 on a second container 120, aligning and stabilizing mechanical components, or creating a seal to prevent leakage of fluids or gases. The interference-fit mechanism may be designed with specific tolerances and material properties to accommodate the required level of engagement and to ensure reliable performance in the intended application. As used in this disclosure, a "receiving port" is a structural feature configured to accept, align, or interface with a corresponding component or mechanism. The receiving port may be an opening, recess, slot, or cavity designed to securely engage with the mating component. The receiving port may provide a stable connection, alignment, or sealing between two elements. In an embodiment, the receiving port may include additional features such as ridges, grooves, or threads to facilitate specific types of engagement, such as interference-fit, snap-fit, or threaded connections. The receiving port may be configured to provide functionality such as fluid transfer, mechanical support, electrical connection, and the like.

With continued reference to FIG. 1A, container 102 may include recyclable beverage pods, having a cavity and an interior surface within cavity. As used throughout this disclosure, a “highly recyclable beverage pod” may additionally be referred to as “beverage pod.” Beverage pod may include a cavity with an interior surface and an exterior surface. The cavity may contain a circular shape, a cylindrical shape and/or any cup-like shape. In some cases, the cavity may include a singular opening. In some embodiments, the exterior surface of the cavity may include grooves, such as twist grooves, that may be used to stack one or more empty beverage pods on top of, and/or within one another. These twist grooves may be raised on the exterior surface of the pod or indented into the exterior surface of the pod. Alternatively, the groove may be on the interior surface of the pod in either a raised or indented formation. The twist grooves may be further described as a lip that protrudes from a surface in a helical groove and/or sets of grooves that configure a helix on one or more surfaces of the pod. This protrusion may be accomplished through the use of additional material being added to one or more surfaces. Alternatively, the protrusion may be accomplished through the stamping of a surface, creating an indentation on a surface and a protrusion on the alternate surface. For example, and without limitation, a twist groove may be stamped onto the exterior surface of a pod, and therefore the protrusion would be on the interior surface, while the indentation would exist on the exterior surface. In an additional nonlimiting example, this would be the opposite should the pod be stamped on the interior surface. As used in this disclosure, “twist grooves” refer to grooves used to convert between rotational and linear movement or force. In one or more embodiments, a twist groove may include a helical structure. Alternatively, in an embodiment, the exterior and/or interior surface of the cavity may include round and/or oval recesses or detents along the sidewall of the cavity. In this embodiment, when beverage pods are stacked within one another the recesses or detents may interconnect and lock one another together. The alignment of the recesses or detents may be straight, staggered, and/or contain a threaded channel guiding the interlocking feature. In an embodiment, beverage pod may include circumferential beads along the surface of the shell. In this embodiment, when the pods are stacked and pressed together, they may interconnect and lock together. The orientation of the circumferential beads may include a straight or aligned pattern of beads. Alternatively, the orientation of the circumferential beads may be staggered and/or in a diagonal pattern in relation to the lip of the pod. In an embodiment, the shell material may include the use of aluminum. In some cases, the shell may be comprised of an aluminum alloy and/or one or more materials. In some cases, the cavity may contain a polymeric coating on an interior surface of the shell. The polymeric coating may have a specified weight and thickness. Non-limiting exemplary embodiments of polymeric coating may include pullulan, hydroxypropyl methylcellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, gum arabic, polyacrylic acid, methyl methacrylate copolymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, polysaccharides, natural gums, polypeptides, polyacrylates, starch, gum karaya, and/or mixtures thereof. In an exemplary non-limiting embodiment the cavity may contain a polymeric coating of a specified composition, such as co-extruded polypropylene with a weight of ~30g/m2 and a thickness of ~27 microns. As used in this disclosure, “co-extrusion” is the process of pressing two or more materials through the same mold to produce a single piece. In this process, two or more orifices are arranged in such a way that the fusion and interlocking of the extrusions take place and a laminar structure is formed before cooling. “Co-extruded polypropylene,” refers to a bi-orientated polymer film obtained from an extrusion process. Qualities the co-extruded polypropylene may possess are good optical qualities, a good barrier towards humidity, and a low barrier towards oxygen. This component may be accomplished in the manufacture of the preliminary shell of the beverage pod through a secondary process of dipping, brushing, and/or spraying of the polymeric coating onto the interior surface of the cavity. Furthermore, this process may occur prior to a manufacturing process configured to shape the shell or after the shaping process has occurred. For example, and without limitation, in an embodiment where stamping is utilized brushing of the polymeric coat may be applied prior to the shaping of the shell.

In some cases, beverage pod may be configured for repetitive use. Receiving a beverage pod may in some embodiments, include receiving an individual beverage pod by way of manual separation and/or similar processes that produce a singular receipt of a beverage pod. Alternatively, in some embodiments, receiving a beverage pod may include an automatic de-nesting process.

With continued reference to FIG. 1A, in an embodiment, de-nesting beverage pods may be de-nested, wherein de-nesting a beverage pod may include providing a plurality of beverage pods and de-nesting one or more beverage pods. As used in this disclosure, “de-nesting” refers to the process of removing one or more beverage pods from a stack of one or more beverage pods. In some cases, one or more beverage pods may be unfilled and efficiently stacked prior to receipt. In some cases, de-nesting of one or more beverage pods includes the use of a de-nesting machine. A “de-nesting machine,” as used in this disclosure, is an automated machine designed with accuracy, reliability, and improved effectiveness in de-nesting. De-nesting machines may automate the manual repetitive task of separating and setting a beverage pod on a conveyor line. Exemplary, non-limiting embodiments of a de-nesting system may include a peel de-nester, a pick and slide de-nester, a pick and place de-nester, and/or a robotic solution configured to complete a non-traditional de-nesting process. In an embodiment, the de-nesting system may utilize vacuum picking technology. Vacuum picking technology utilizes the differences in pressure between atmospheric pressure and the vacuum applied over the contact area, providing lifting force. This may allow a beverage pod to be lifted and placed in a designated area. In some embodiments, a beverage pod may require unlocking from the beverage pod it is nested in. In this embodiment, the de-nesting system may further require a twisting action to unlock the beverage pods from one another. In some embodiments, beverage pods may be locked together by way of circumferential beads, which may require additional lifting force in order to unlock the pods from one another. Alternatively, in an embodiment including circumferential beads, the storage of the nested pods may be in a way in which the pods have not been locked into one another. In an embodiment, and without limitation, one or more beverage pods may be placed into an infeed pocket of a machine. The infeed pocket may then transport the beverage pod to subsequent unit operations in the process. This may be done using a specific and gentle process to ensure the easily damaged cups are damage-free. For example, and without limitation, in an embodiment including aluminum beverage pods the beverage pods may have a nested or stacked clearance of 4.1 mm between flanges. “Flanges,” as used in this disclosure, are projecting rims of a structure. In one or more embodiments, flange may be used in beverage pods, otherwise described as the top of the beverage pod. The de-nesting process may further include singulation. The singulation process may allow for an individual beverage pod to be selected out of a larger batch of beverage pods and processed independently of the overall batch of beverage pods. Singulation may be used in lieu of or in tandem with the de-nesting process.

With continued reference to FIG. 1A, filter disc may be placed into a cavity of beverage pod. A filter disc may be used to prevent damage to a filter when the beverage pod is filled with heavier gram weight beverage materials. Heavier gram weight materials may require a larger and/or deeper filter inside the beverage pod. The larger and/or deeper filter might obtain damage when the discharge needle enters the underside of the beverage pod; the use of a filter disc may aid in preventing such damage. The “discharge needle” refers to the needle that pierces the beverage pod in the process of use of the beverage pod in making a beverage. A “filter disc” is a type of filter that may be used to filter various fluids. The use of the filter disc here may allow for the passage of liquid while preventing the passage of beverage materials that may make it through the preformed filter material adhered to at least an interior surface of the cavity. In an embodiment, a filter disc may include materials such as fiber, granular beds, woven fabrics, and/or metal screens. Furthermore, filter discs may be embodied in a circular, oval, and/or similar shape. The size and shape may directly relate to the size and shape of the beverage pod and specific placement of the filter disc. The process of placing the filter disc into the cavity of beverage pod may include removing an individual filter disc from a bulk supply, singulation, and precise placement of the filter disc into the beverage pod. In an embodiment, and without limitation, removing a filter disc from a bulk supply may be accomplished through a similar de-nesting process as previously discussed, and/or manually. Furthermore, in an embodiment de-nesting of a filter disc may be accomplished by a de-nesting system that utilizes friction feeding techniques and/or technology. As used in this disclosure, “singulation” is a process configured to take a group of side-by-side products and form them into a straight line with proper justification. Therefore, in an embodiment, singulation of the beverage pods may occur in preparation of precise filter disc placement. Placement of the filter disc may be located at the most distant point from the opening of the cavity of the beverage pod. The most distant point may further be described as the floor of the cavity of the beverage pod. Alternatively, placement of the filter disc may position the filter disc up off the floor, wherein there is space between the floor of the cavity and the start of where the filter disc may rest within the cavity. This space between the floor of the cavity and the start of the filter disc may depend on the beverage material weight being inserted into the beverage pod. For example, and without limitation, a beverage material that requires more room within the cavity may require a larger space between the floor and the start of the filter disc.

In further reference to FIG. 1A, in an embodiment, filter material forming may be applied in a container 102 manufacturing, wherein filter material forming includes forming the filter material and press-forming the formed filter material. “Filter material,” for the purposes of this disclosure, is any material configured to separate mediums or substances. In one or more embodiments, mediums or substances may include liquids and solids. For example, and without limitation, filter material may be configured to separate coffee and coffee grounds. The manufacture of filter material may occur as a separate process of manufacture from method 100 as an additional preliminary method of manufacture. Manufacture of filter material may include a process of pulping, forming, drying, finishing, and packaging. Pulping may be accomplished by breaking down wood, abaca, and/or other materials into small fibers using mechanical and/or chemical means. The fibers may then be mixed with water to create a slurry, which is then filtered and cleaned to remove impurities. The next step, forming, refers to the formation of the pulp into sheets or rolls of paper using a Fourdrinier machine. This machine consists of a series of rollers and mesh screens that help to shape and dry the paper. Once formed, the paper may then be dried using heat and/or pressure. In an embodiment, drying may occur by passing the paper through large drying cylinders, which may be configured to remove excess moisture and help to set the fibers in place. The paper may then be cooled and cut into the desired shape and size. Finishing occurs once the paper has been dried and may include subjecting the paper to various finishing processes to improve its appearance and/or functionality. For example, and without limitation, this may include bleaching, calendaring or smoothing, and/or coating. A further embodiment may include printing or branding of information. Lastly, the finished paper is packaged in bags, boxes, and/or placed on a ream. In some cases, formed filter material may be created from a bulk supply of filter material such as a roll stock or a ream of sheets. Exemplary, nonlimiting embodiments of filter material may include roll stock of 35 grams per square meter (GSM) to 38 GSM of material including a combination of cellulose, abaca, and/or polymeric fibers. GSM refers to the weight of the fabric, in this instance 35-38 GSM may be considered a lightweight material. In an embodiment, forming the filter material may include cutting and/or punching out the roll stock and/or ream of sheets. For example, and without limitation, filter material may be formed by a die-cut machine. “Die-cutting,” as used in this disclosure, refers to the process in which a machine is used to mass-produce cut-out shapes. Die-cutting allows for the creation of the same shape, with the exact same dimensions, saving both time and creating uniformity. In an embodiment, the filter material may be die-cut into a specific round disc dimension. For example, and without limitation, between 95mm and 100mm. In some embodiments, the dimension may be adjustable and based on specific dimensions of the beverage pod. Once the filter material is formed, the material may be press-formed into an efficient design containing pleats and/or creases which enable the containment of beverage materials. As used in this disclosure, “press-forming” refers to the manufacturing process that involves shaping a material by applying pressure to it using a press. The pleated and/or creased features of the filter material enable improved extraction of the beverage liquid from the beverage materials due to increased surface area as compared to a straight and/or smooth sidewall filter. In an embodiment, the formed filter material may be stacked and/or transferred to the next step in the process individually to avoid the need for de-nesting. The result of this step in the process is pre-formed filter material conveyed to the next step in the process. Alternatively, in a nonlimiting embodiment, the pre-formed filter material may be provided by another source outside the present method.

Still referencing FIG. 1A, adhering a formed filter material within the cavity of the beverage pod may include receiving a pre-formed filter material, placing the pre-formed filter material within the cavity of the beverage pod, and sealing the pre-formed filter material to the interior of the beverage pod. In some embodiments, pre-formed filter material may be precisely inserted and/or positioned into the cavity of beverage pod in preparation for adherence to the interior of the pod. As an exemplary non-limiting embodiment, precise position of the pre-formed filter may allow for 10.0 mm of clearance between the underside of the filter and the inside bottom of the beverage pod. Adhering the pre-formed filter material within the cavity may further include sealing the pre-formed filter material to the cavity. The sealing process marries two materials and creates a bond. To achieve this bond, one of the materials, such as the interior surface of the beverage pod, may carry a surface sealant layer. The heating elements of heat seal packaging equipment are raised to a temperature high enough to either melt or activate the sealant material, therefore allowing adhesion to take place. Once heated to a specific temperature and left to dwell for a certain period of time, pressure may be applied to create the bond between the sealant layer and the material, such as the filter material. Adherence of the pre-formed filter material to the interior of the beverage pod may be possible using various technologies. The filter material may contain a specific formula blend of non-woven cellulose fibers and abaca fibers combined with non-woven polymeric fibers and finished to a particular caliper or basis weight. The interior of the beverage pod may contain a polymeric coating of a specified composition and weight/thickness. The attachment of the filter material to the beverage pod interior may be accomplished using a specified technology for a specified time, temperature, and pressure. For example, and without limitation, convection heat sealing, ultrasonic sealing, and/or adhesive sealing. The exact parameters of the material and the attachment process may be specific to the material used in the configuration of the beverage pod. For example, and without limitation, an aluminum beverage pod sealing procedure may include the following sealing conditions: a temperature range of 250 to 325 degrees Celsius, a dwell range of 0.4s to 2.0s, and contact pressure of ~1200 N/m2. Other materials may have similar sealing conditions. As used in this disclosure, “temperature range” refers to the range of temperature to be applied in the sealing process to enable a proper seal. Likewise, a “dwell range,” refers to the period of time in which the beverage pod must be heated prior to contact pressure being applied. “Contact pressure,” as used in this disclosure, refers to the amount of pressure applied to fully secure the filter material to at least a sidewall of the beverage pod. In some cases, the formed filter material may be adhered to an inner surface of the cavity. In some cases, the formed filter material may blanket at least a portion of an inner surface of the cavity. Additionally, in some embodiments, the inner cavity may contain a polymeric coating configured to adhere the formed filter material to the cavity. In some cases, the polymeric coating may be applied to the interior cavity through spraying, dipping, brushing and/or the like. An exemplary, non-limiting embodiment may include a polymeric coating including co-extruded polypropylene with a weight of ~30g/m2 or thickness of ~27 microns. In some cases, formed filter material may be removable with the introduction of minor force. For example, a user may be able to peel the formed filter material from the surface of the cavity, wherein a user may be able to discard the formed filter material. In some cases, formed filter material may be glued, adhered, sealed and/or welded to the surface of the cavity in any of the embodiments as described within this disclosure.

With continued reference to FIG. 1A, filled formed filter material may be adhered to an interior of a cavity with beverage material, having a headspace atmosphere. “Beverage material” for the purposes of this disclosure is a substance that may interact with a fluid to provide a flavored beverage. In some cases, beverage material may include ground coffee beans wherein water may interact with the coffee beans to create coffee. Alternatively, beverage material may include cocoa powder, lemonade powder and/or any additional powder that may be used to create a beverage. In some cases, beverage material may include a concentrated liquid wherein the concentrated liquid may interact with a fluid to provide a less concentrated beverage. In some cases, filling the formed filter material adhered to the interior of the cavity with beverage material, having a headspace atmosphere may include filling the beverage pod with ground coffee beans. In some cases, formed filter material may be configured to allow a liquid to pass through while the beverage material may be held by the filter material. For example, coffee grounds may be mixed with a liquid wherein coffee may seep out of the filter material while the coffee grounds are held back by the filter material. In some embodiments, beverage material may react with a fluid wherein the beverage material may dissolve and pass through formed filter material. Additionally, in some cases, formed filter material may blanket a surface of cavity wherein beverage material may be disposed on top of formed filter material. In an embodiment, beverage material may fill cavity of beverage pod and/or alternatively, at least partially fill cavity of beverage pod. In some cases, the filling of the formed filter material adhered to the interior of the cavity with beverage material, having a headspace atmosphere may require a precise process. This precise process may be critical in order to enhance the beverage taste to the consumer and create a consistent taste from pod to pod. The precise filling process may be possible with the use of various machines and/or processes such as, but not limited to auger feeding, volumetric filling, and the like. Due to the size of the pod, exacting filling parameters may be specified and may be unique to the specific size and/or material-type associated with the beverage pod. For example, and without limitation, in the instance of an aluminum beverage pod, the filling parameters may include an auger feeding machine set to 9.0g, 10.0g, 11.0g, 12.0g, and/or 13.0g, each having a fill tolerance of +/- 0.1g. Filling parameters may be adjustable and specific to the beverage material being used to fill the beverage pod.

With continued reference to FIG. 1A, headspace atmosphere within cavity may be modified. “Headspace” for the purposes of this disclosure is any gaseous substance that is situated within and/or above beverage material within the beverage pod. For example, headspace may include oxygen wherein the oxygen may be situated between and/or on top of the beverage material. The degradation of beverage materials and/or ingredients may occur in the presence of oxygen. This degradation may shorten the shelf-life and freshness of beverage materials and their ingredients. Therefore, there may be a need to remove any oxygen within the cavity of beverage pod in order to preserve the freshness of the beverage material within the cavity. In an embodiment, modifying headspace atmosphere may include displacing oxygen. In some cases, displacing headspace oxygen may include removing oxygen through a vacuum process. In an embodiment where the modification of headspace occurs through a vacuum process, the sealing process may occur prior to the modification of headspace. Alternatively, in some embodiments, removing headspace oxygen may include the introduction of an inert gas, such as, without limitation, nitrogen. The process of modifying headspace may be done through the introduction of an inert gas to displace headspace oxygen within the filled pods to a specific value prior to hermetically sealing the pod. In an embodiment including aluminum beverage pods, as aluminum is a superior oxygen barrier material, the shelf-life and freshness of the aluminum pods using modified atmosphere may be superior to plastic pods. As a non-limiting example, headspace oxygen levels in an embodiment including aluminum beverage pods may be less than 2%.

With continued reference to FIG. 1A, cavity with an airtight lid may be sealed. An airtight lid may be configured to prevent beverage material from interacting with the atmosphere exterior to the interior of the cavity. In some cases, airtight lid may provide for an airtight seal between beverage material and the surrounding atmosphere. In some cases, airtight lid may include aluminum, plastic and/or any combination thereof. In some cases, airtight lid may include a pull tab wherein a user may grip onto pull tab in order to remove airtight lid. In some cases, airtight lid may be received from a bulk supply of precisely cut lids. Sealing the cavity with an airtight lid may include the singulation and precision placement of individual pod lids onto the top flange or surface of each pod. The dimensions and material composition of airtight lid may be specific to the orientation and material of the other segments of the beverage pod, such as without limitation the shell and or the filter material composition. The airtight lid material will enable a hermetic seal capable of surviving high altitude distribution as well as allowing easy removal, for example by peeling the lid from the pod by the consumer after preparing a beverage. As used in this disclosure, “hermetic” is a complete and airtight lid. The lid material may be a specified combination of a metallic material, and polymeric coatings and/or laminates on the interior or sealing surface. In an embodiment, there may further be an exterior portion to the lid configured to display print of some sort. The lid may be sealed/welded/adhered to the aluminum pod using one of several potential technologies. For example, and without limitation, convection heat sealing, ultrasonic welding, and/or adhesive sealing. Embodiments may use exacting specifications for time, temperature, and pressure. In some cases, sealing the lid may include hermetically sealing, welding, adhering and the like. For example, in an embodiment with an aluminum beverage pod the sealing conditions may include the use of convection heat sealing methods, including a temperature range of 240 to 350 degrees Celsius, a dwell time range of 0.4s to 2.0s, and contact pressure of ~1200 N/m2. Containers may include recyclable beverage pods characteristic, as described in U.S. Nonprovisional Application No. 18/599,862, filed on March 8, 2024, and entitled “HIGHLY RECYCLABLE BEVERAGE PODS AND METHOD OF MANUFACTURE,” and having attorney docket no. 1326-003USU1.

Still referring to FIG. 1A, in some embodiments, container 102 may include a food container 102 made using a multi-layer sheet. A multi-layer sheet may include a multi-layer laminate sheet. A multi-layer sheet may include primarily aluminum and/or polypropylene. In some embodiments, multi-layer sheet includes a first side and a second side. A container 102 may be manufactured such that first side is on the outside of container 102 and second side is on the inside of container 102. As described below, second side may also make up a top surface of a food container 102 onto which a lid is attached. In some embodiments, a multi-layer sheet includes, from first side to second side, first lubricant layer, varnish layer, printing ink layer, primer layer, aluminum layer, coextrusion coating, and second lubricant layer.

Still referring to FIG. 1A, in some embodiments, container 102 may be made using a multi-layer sheet including a first lubricant layer. A first lubricant layer may be positioned on the outside of container 102. As used herein, a “lubricant layer” is a layer whose presence reduces friction, adhesion, or both, between two materials which would otherwise be adjacent. In some embodiments, a lubricant layer has a silicone base. In some embodiments, a lubricant layer may make up about .1% of a multilayer sheet by weight. In some embodiments, a lubricant layer in a finished food container may weigh about .002g. In some embodiments, a lubricant layer may make up about .2% of a multilayer sheet by weight. In some embodiments, a lubricant layer in a finished food container may weigh about .004g. In some embodiments, a multi-layer sheet may include a first lubricant layer on a first side and a second lubricant layer on a second side. In some embodiments, a plurality of lubricant layers may make up about .2% of a multilayer sheet by weight. In some embodiments, a plurality of lubricant layers in a finished food container may weigh about .004g. In some embodiments, inclusion of a lubricant layer may aid in a deep drawing process, such as by making it easier to take container out of a deep drawing machine. In some embodiments, one or both lubricant layers may have a weight per area of multi-layer sheet of .55±.15g/m².

Still referring to FIG. 1A, in some embodiments, container 102 may include a varnish layer. As used herein, a “varnish layer” is a material which is at least partially transparent. In some embodiments, a varnish layer may be positioned immediately inside of first lubricant layer. For example, a varnish layer may be positioned between the first lubricant layer and the center of container in a finished single-use container 102. In some embodiments, a varnish layer may have a polyurethane base. In some embodiments, a varnish layer may make up about .72% of multilayer sheet by weight. In some embodiments, a varnish layer in a finished food container may weigh about .015g. In some embodiments, varnish layer may have a weight per area of multi-layer sheet of 2 ±.5g/m².

Still referring to FIG. 1A, in some embodiments, container 102 may include a printing ink layer. As used herein, a “printing ink layer” is a material which is at least partially non-transparent. In some embodiments, a printing ink layer may be positioned immediately inside of varnish layer. For example, a printing ink layer may be positioned between the varnish layer and the center of container in a finished single-use container 102. In some embodiments, a printing ink layer may have a polyvinyl butyral base. In some embodiments, a varnish layer may have negligible weight in comparison to other components of a multi-layer sheet.

Still referring to FIG. 1A, in some embodiments, container 102 may include a primer layer. As used herein, a “primer layer” is a material onto which a printing ink layer is applied. In some embodiments, a primer layer may be positioned immediately inside of printing ink layer. For example, a primer layer may be positioned between the printing ink layer and the center of container in a finished single-use container 102. In some embodiments, a primer layer may have an acrylate base. In some embodiments, a primer layer may have a polyester base. In some embodiments, a primer layer may make up about .72% of multilayer sheet by weight. In some embodiments, a varnish layer in a finished food container may weigh about .015g. In some embodiments, primer layer may have a weight per area of multi-layer sheet of 2 ±.5g/m².

Still referring to FIG. 1A, in some embodiments, container 102 includes an aluminum layer. As used herein, an “aluminum layer” is a material that includes aluminum, an aluminum alloy, or both. In some embodiments, an aluminum layer may be positioned immediately inside of primer layer. For example, an aluminum layer may be positioned between the primer layer and the center of container in a finished single-use container 102. An aluminum layer may be made from recycled aluminum and/or aluminum alloy, virgin aluminum and/or aluminum alloy, or a combination thereof. In some embodiments, an aluminum layer may have a thickness of 90 µm ±8%. In some embodiments, an aluminum layer may have a thickness of 82.8 µm to 97.2 µm. In some embodiments, an aluminum layer may make up about 87.59% of multilayer sheet by weight. In some embodiments, an aluminum layer in a finished food container may weigh about 1.816 g. In some embodiments, aluminum layer may have a weight per area of multi-layer sheet of 243.9 ± 20 g/m2.

Still referring to FIG. 1A, in some embodiments, aluminum layer may include an aluminum alloy such as Aluminum 3004-H19. In some embodiments, an aluminum layer may include 95.5%-98.2% aluminum, ≤.25% copper, ≤.70% iron, .80%-1.3% magnesium, 1.0%-1.5% manganese, ≤.3% silicon, ≤.25% zinc, and ≤.15% other (with each element of the “other” category being ≤.05%).

Still referring to FIG. 1A, in some embodiments, container 102 includes a coextrusion coating. As used herein, a “coextrusion coating” is a material which contains a plurality of polymer types. In some embodiments, a coextrusion coating may be positioned immediately inside of an aluminum layer. For example, a coextrusion coating may be positioned between the aluminum layer and the center of container in a finished single-use container 102. In some embodiments, a coextrusion coating may include a tie layer and/or a heat seal layer. As used herein, a “tie layer” is an adhesive material. For example, a tie layer may provide adhesion between 2 layers which would normally not adhere to each other. In some embodiments, a tie layer may include a polypropylene base. As used herein, a “heat seal layer” is a material which conducts heat poorly. In some embodiments, a heat seal layer may include a polypropylene base. In some embodiments, a coextrusion coating may include a mix of a tie layer and a heat seal layer, such that they do not make up distinct layers. In some embodiments, a coextrusion coating may include a tie layer and a heat seal layer which are distinct. In some embodiments, a coextrusion coating may make up about 10.77% of multilayer sheet by weight. In some embodiments, a coextrusion coating in a finished food container may weigh about .223g. In some embodiments, coextrusion coating may have a weight per area of multi-layer sheet of 30 ±3g/m².

Still referring to FIG. 1A, in some embodiments, container 102 may include a second lubricant layer. Second lubricant layer may be an innermost layer of container. For example, second heat seal layer may be positioned between coextrusion coating and the interior of single-use coffee pod. Second lubricant layer may include one or more features described above with respect to first lubricant layer.

Still referring to FIG. 1A, in some embodiments, container 102 may have a total mass of 2.074g. In some embodiments, multi-layer sheet has a mass per area of 278.45g/m². Multi-layer sheet may include multi-layer sheet characteristic as described in U.S. Nonprovisional Application No. 18/634,607, filed on April 12, 2024, and entitled “SINGLE USE CONTAINERS AND METHODS OF MANUFACTURING,” and having attorney docket no. 1326-006USU1.

Still referring to FIG. 1A, a container 102 may be manufactured by a three-dimensional (3D) printing apparatus. “Three-dimensional (3D) printing apparatus,” as used in this disclosure, is a machine configured to fabricate a three-dimensional object. In one or more embodiments, 3D printing apparatus may be used to make object by depositing, curing, or solidifying material in sequential layers according to a digital model. In one or more embodiments, three-dimensional printing apparatus may include a fused deposition modeling (FDM) printer configured to extrude a thermoplastic filament through a heated nozzle to form successive layers of a container body, including an open end 104, a closed end 108, and a body wall 112 extending between open end 104 and closed end 108. In one or more embodiments, thermoplastic filament may include polylactic acid (PLA), polyethylene terephthalate glycol (PETG), polypropylene (PP), or acrylonitrile butadiene styrene (ABS). In one or more embodiments, three-dimensional printing apparatus may include a stereolithography (SLA) printer configured to selectively cure a liquid photopolymer resin using a light source to form high-resolution lock features, including bayonet projections, threads, or detent geometries. In one or more embodiments, three-dimensional printing apparatus may include a selective laser sintering (SLS) system configured to fuse powdered polymer material using a laser energy source. In one or more embodiments, powdered polymer material may include nylon (polyamide). In one or more embodiments, three-dimensional printing apparatus may include a multi-material printer configured to deposit two or more materials within a single build process. “Digital model,” as used in this disclosure, is a computer-generated three-dimensional representation of a container or component. In one or more embodiments, digital model may include a representation including geometric data that defines external surfaces, internal cavities, wall thicknesses, and functional features such as end lock features, recesses, protrusions, threads, or bayonet geometries. In one or more embodiments, digital model may be created using computer-aided design (CAD) software. In one or more embodiments, digital model may include dimensional tolerances, draft angles, fillet radii, and interference values configured to control fit between container 102 and a second container 120. In one or more embodiments, digital model may be processed by slicing software configured to convert the three-dimensional representation into a series of two-dimensional cross-sectional toolpaths corresponding to successive fabrication layers. “Layering,” as used in this disclosure, is a fabrication process in which material is deposited, cured, or fused in a sequence of discrete strata along a build axis to form a three-dimensional structure. In one or more embodiments, layering may allow formation of complex geometries including undercuts, internal channels, and integrated locking features that may be difficult to form using subtractive manufacturing processes. In one or more embodiments, interlayer bonding strength may be controlled by adjusting temperature, energy input, deposition rate, or curing parameters to achieve structural integrity suitable for stacking loads and locking engagement forces.

Now referring to FIG. 1B, an exemplary illustration 100b of a cross sectional view of two containers with top lock features, wherein the two containers are stacked in an unlocked position. Without limitation, the two containers may be aligned such that open end 104 of the lower container is positioned beneath closed end 108 of the upper container, with the respective top lock features proximate to one another but not engaged. In this unlocked position, the top lock features of the two containers may be spatially aligned to allow for subsequent engagement if desired. The cross-sectional view illustrates the structural configuration of the top lock features, which may include interlocking tabs, ridges, or other mechanisms designed to securely connect the containers when engaged. Body wall 112 of the containers remain in contact or near-contact along their stacking interface, providing stability during stacking. In illustration 100b, no mechanical engagement has yet occurred between the lock features, ensuring that the containers can be easily separated or repositioned. The unlocked position may facilitate convenient storage, transport, or staging of the containers prior to locking.

Now referring to FIG. 1C, an exemplary illustration 100c of a cross sectional view of two containers with top lock features, wherein the two containers are stacked in a locked position. Without limitation, the top lock features of the containers are fully engaged, securing the containers together to prevent unintentional separation or misalignment. In an embodiment, to achieve the locked position, a downward force may be applied to the upper container, causing the top lock feature of the upper container to engage with the corresponding lock feature on the lower container. The application of the downward force may facilitate the alignment and interaction of interlocking components, such as tabs, ridges, or protrusions, ensuring a secure mechanical connection. The illustration may include top lock features that may be designed to interlock with precision, providing stability and preventing relative movement between the stacked containers. Continuing, the locked configuration may enhance the integrity of the stack during handling, transport, or storage while allowing for easy disassembly by reversing the locking action. In an embodiment, the stacking height may be maintained within a range of 5.3 mm to 6.3 mm to ensure proper alignment, stability, and compatibility between stacked components. As used in this disclosure, a "stack height" refers to the vertical distance measured from the base or bottom of a lower container or component to the top or highest point of an upper container or component when the containers or components are stacked in a vertical arrangement. Stacking height may be a critical dimension that ensures proper alignment, stability, and functionality of the stacked assembly, particularly in applications where secure engagement or uniform spacing is required. Continuing, the stack height range may accommodate minor variations in manufacturing tolerances while meeting functional and structural requirements. In an embodiment, the containers may be designed to stack easily under low axial forces, such as the weight of the containers themselves when placed on top of each other. Continuing, this may ensure effortless stacking for storage or transportation without the need for significant external force. Additionally and or alternatively, the containers may be configured to lock securely under higher axial forces, which may be applied intentionally by a user. Continuing, the higher force may trigger the engagement of the locking mechanism, providing a stable and secure connection between stacked containers. This dual-force approach allows for convenient handling and reliable locking, balancing ease of use with functionality. At least an end lock feature 116 may be configured to engage only upon application of a user applied axial force exceeding a predefined threshold. In one or more embodiments, predefined threshold may be between 10 Newton (N) and 30 N for a single-hand “press-to-lock” engagement that is intended to feel similar to a firm push-button or light snap-fit engagement (for example, about 15 N, about 20 N, about 25 N, or about 30 N). In one or more embodiments, predefined threshold may be between 30 N and 70 N (for example, about 35 N, about 45 N, about 55 N, or about 65 N) for a more deliberate “press-to-engage” configuration intended to reduce accidental locking while still being achievable by most adult users using a palm press or two-handed press. In one or more embodiments, predefined threshold may be greater than 70 N (for example, between 70 N and 120 N) for configurations targeting higher resistance to inadvertent or unintended engagement.

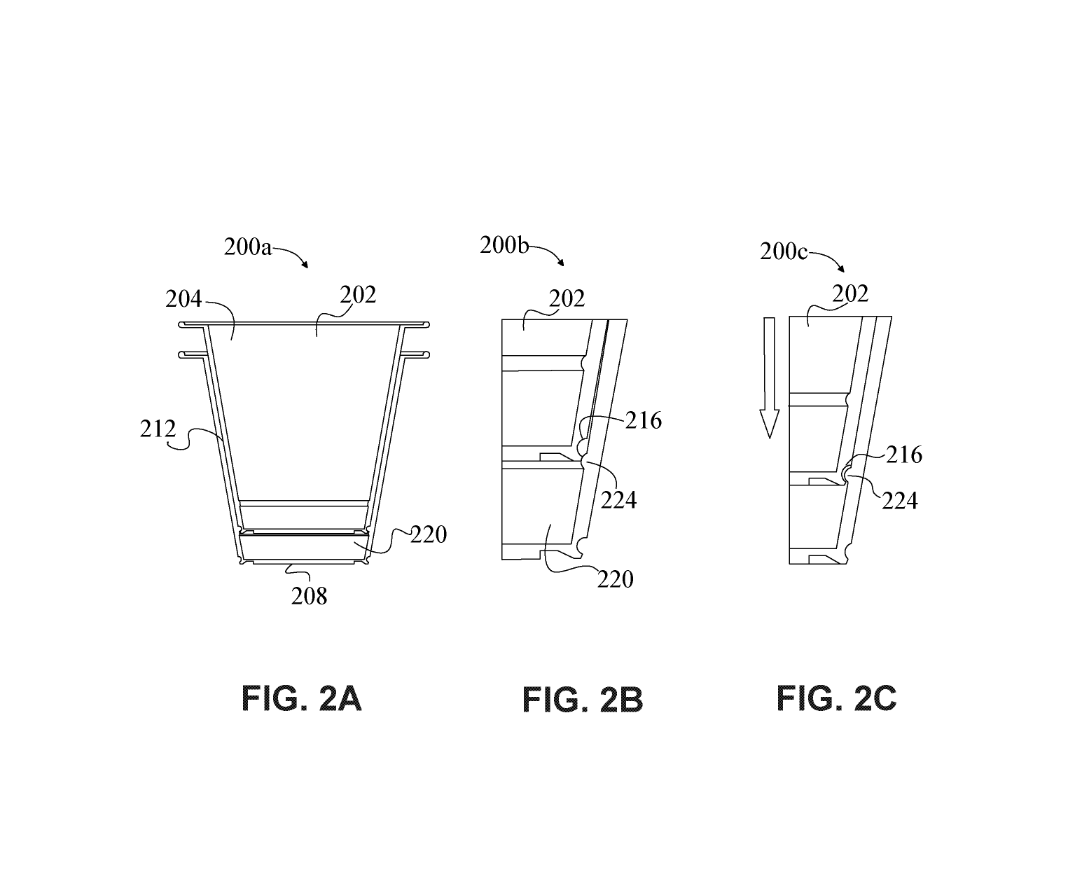

Now referring to FIG. 2A, an exemplary illustration 200a of a side view of two containers with bottom lock features. In an embodiment, container 202 may be designed to be stackable such that dimensions of container 202 allow them to fit snugly inside each other. In one or more embodiments, container 202 may be designed to be stackable such that dimensions of container 202 allow them to nest in a controlled, guided manner, wherein an outer surface of a body wall 212 of a first container may be dimensioned to closely correspond to an inner surface of a body wall 212 of a second container 220. In one or more embodiments, dimensional correspondence may establish a clearance fit that limits lateral movement while permitting axial insertion of one container into another without deformation. In one or more embodiments, nesting relationship may be characterized by an interference-limited or tolerance-controlled fit, in which radial clearance between containers may be sufficiently small to promote alignment and stability, yet sufficiently large to avoid frictional locking or unintended engagement of locking features during passive stacking. Continuing, the bottom lock feature may be designed so that the force of gravity alone is insufficient to engage or "activate" the lock. Without limitation, additional force, applied manually by the user, may be required to fully engage the bottom lock feature and secure containers together. In this manner, nesting fit may provide positional guidance and stack stability, while remaining functionally distinct from a locked configuration. Continuing, this may ensure that the containers remain separate and do not inadvertently lock when simply stacked. Single use container 202 includes a container body, wherein the container body includes an open end 204, a closed end 208, a body wall 222 between open end 204 and closed end 208, and at least an end lock feature 226, wherein the end lock feature is configured to lock the single use container 202 into a second container 220 by engaging with a corresponding feature 224 on second container 220. At least an end lock feature 216 may include a bottom lock. As used in this disclosure, a "bottom lock feature" is a locking mechanism located at or near closed end of a container body, configured to engage with a corresponding feature on a second container or component. The bottom lock feature may include structural elements such as grooves, recesses, ridges, or other interlocking components designed to provide a secure connection, alignment, or stability between the two containers only upon application of a deliberate engagement force exceeding that generated by gravitational stacking alone.

With continued reference to FIG. 2A, the container body may be constructed from a metal material. With continued reference to FIG. 2A, the container body may include a coating material applied to body wall 212. With continued reference to FIG. 2A, the at least a bottom lock feature may include an interference-fit mechanism configured to align with a receiving port on the second container and lock with the receiving port on the second container. This may be implemented as described and with reference to FIGS. 1A-1C.

Now referring to FIG. 2B, an exemplary illustration 200b of a cross sectional view of two containers with bottom lock features, wherein the two containers are stacked in an unlocked position. In an embodiment, closed end 208 of the upper container rests on or near closed end 208 of the lower container, with the respective bottom lock features of the containers in close proximity but not engaged. In an embodiment, the unlocked position allows for the containers to be stacked for storage or transport while remaining unconnected, facilitating easy separation or repositioning as needed. The illustration highlights the structural configuration of the bottom lock features, which may include grooves, ridges, or other interlocking components that are specifically designed to engage when a locking force is applied. This may be implemented as described and with reference to FIGS. 1A-2A.

Now referring to FIG. 2C, an exemplary illustration 200c of a cross sectional view of two containers with bottom lock features, wherein the two containers are stacked in a locked position. This may be implemented as described and with reference to FIGS. 1A-2B. In one or more embodiments, in locked position, a bottom lock feature disposed at or near closed end 208 of an upper container may be fully engaged with a corresponding receiving feature formed at or near open end 204 of a lower container, thereby mechanically securing two containers together. In one or more embodiments, bottom lock feature may include an interference-fit mechanism configured to engage receiving feature through dimensional interference, such that at least a portion of bottom lock feature may be dimensioned to be slightly larger than a corresponding portion of the receiving feature prior to engagement. Upon application of a deliberate engagement force, bottom lock feature may elastically deform, compress, or deflect during insertion into the receiving feature and subsequently recover to generate frictional and/or compressive retention forces that resist separation. FIG. 2C illustrates that, unlike an unlocked or passively stacked configuration, bottom lock feature and the receiving feature may be in direct mechanical engagement, resulting in axial retention, lateral constraint, and positional alignment between containers. In this locked position, engagement force may exceed that generated by gravitational stacking alone, thereby ensuring that the locking state may be achieved only through intentional user action. In one or more embodiments, bottom lock feature may include one or more ridges, tabs, protrusions, compliant segments, or surface textures configured to enhance frictional contact with corresponding grooves, recesses, or cavities of the receiving feature. These structures may cooperate to prevent unintended disengagement during handling, transport, or storage once the containers are locked. In locked configuration, body wall 212 of containers may remain in close proximity or contact along the stacking interface, while primary load transfer and retention are provided by engaged bottom lock features. This structural arrangement may improve overall stack stability and resistance to relative axial or rotational movement. In one or more embodiments, at least an end lock feature 216 and corresponding feature 224 may form an interference-fit mechanism wherein at least an end lock feature 216 may include a recess and corresponding feature 224 may include a protrusion. In one or more embodiments, recess may be configured to align with protrusion on second container and to lock with protrusion upon axial insertion beyond a predefined engagement depth. In one or more embodiments, recess may be formed on either upper container or lower container, and protrusion may be formed on other of upper container or lower container, such that functional roles of recess and protrusion are interchangeable between containers. In one or more embodiments, closed end 208 of upper container may include the protrusion and open end 204 of lower container may include the recess, while in other implementations closed end 208 may include recess and open end 204 may include protrusion. In one or more embodiments, recess may include a curved profile, a semi-circular groove, a V-shaped channel, a rectangular slot, a trapezoidal cavity, a polygonal pocket, or combinations thereof. In one or more embodiments, protrusion may include a rounded bead, a semi-circular rib, a rectangular ridge, a tapered barb, a polygonal boss, or combinations thereof, dimensioned to correspond to the recess profile to produce radial interference upon engagement. In one or more embodiments, recess and protrusion may extend continuously along an entire circumferential periphery of the container body to form a continuous annular locking interface. In one or more embodiments, recess and protrusion may extend only along a partial circumferential segment of the container body. In one or more embodiments, multiple spaced recess segments and multiple spaced protrusion segments may be distributed around the periphery, wherein spaced segments collectively define a composite locking structure.

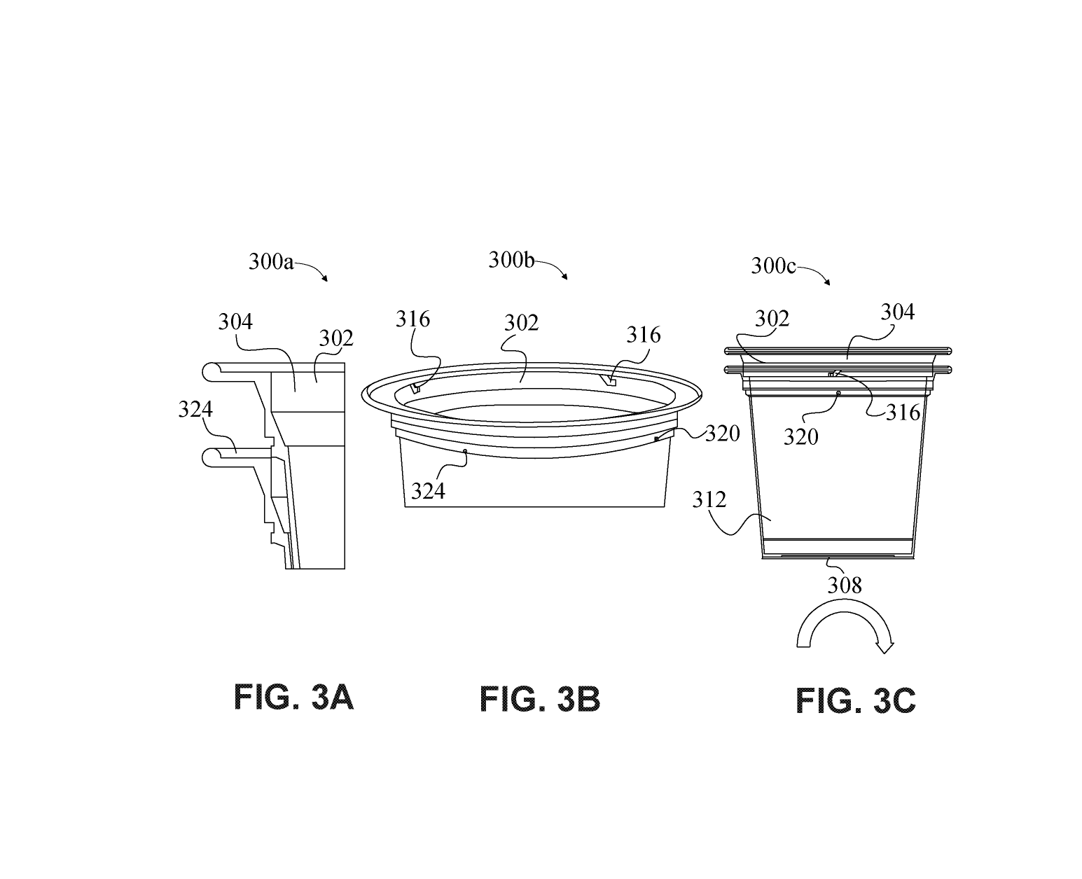

Now referring to FIG. 3A, an exemplary illustration 300a of a cross section view of two containers with bayonet lock features, wherein the two containers are in an unlocked position. In an embodiment, container 302 may be designed to be stackable such that the dimensions of the containers allow them to fit snugly inside each other. In one or more embodiments, container 302 may be designed to be stackable such that dimensions of containers allow them to nest in a controlled, guided manner, wherein an outer surface of a body wall 312 of a first container may be dimensioned to closely correspond to an inner surface of a body wall 312 of a second container 328. Continuing, at least a rotational engagement mechanism 316, or bayonet lock feature may be designed so that the force of gravity alone is insufficient to engage or "activate" the lock. Without limitation, additional force, applied manually by the user, may be required to fully engage at least a rotational engagement mechanism 316, or the bayonet lock feature and secure the containers together. Continuing, this may ensure that the containers remain separate and do not inadvertently lock when simply stacked. A single use container 302 includes a container body, wherein the container body includes an open end 304, a closed end 308, a body wall 312 between the open end 304 and the closed end 308, and at least a rotational engagement mechanism 316 disposed at or adjacent the open end 304, wherein at least a rotational engagement mechanism 316 includes an open configuration 320 and a closed configuration 324, wherein the rotational engagement mechanism is configured to lock the single use container 302 into a second container 328 by engaging with a corresponding feature on second container 328 when rotational engagement mechanism 316 is rotated into the closed configuration. “Rotational engagement mechanism,” as used in this disclosure, is a mechanical locking structure disposed at or adjacent an open end or a closed end of a container body. In one or more embodiments, at least a rotational engagement mechanism 316 may include mechanical locking structure being configured to transition from open configuration 320 to closed configuration 324 through relative rotational movement between a first container and a second container. In one or more embodiments, at least a rotational engagement mechanism 316 may include a bayonet lock feature having at least one axial entry slot and at least one circumferential locking channel, wherein a projection on one container is inserted axially into the entry slot and subsequently rotated into circumferential locking channel to achieve closed configuration. In one or more embodiments, circumferential locking channel may include a ramped or inclined surface configured to draw the containers axially together during rotation. In one or more embodiments, at least a rotational engagement mechanism 316 may include one or more L-shaped slots formed in one container and one or more radially outward protruding lugs formed on the other container, wherein rotation through a predefined angular displacement between 10 degrees and 90 degrees transitions the mechanism from open configuration 320 to closed configuration 324. In one or more embodiments, at least a rotational engagement mechanism 316 may include multiple circumferentially spaced lugs and corresponding slots to distribute load evenly around a periphery of the container body. In one or more embodiments, at least a rotational engagement mechanism 316 may include a helical cam surface formed on one container and a follower surface formed on the other container, wherein relative rotation causes axial displacement through cam interaction. In one or more embodiments, at least a rotational engagement mechanism 316 may include interlocking tabs and recesses configured to engage only after a defined rotational alignment is achieved. “Open configuration,” as used in this disclosure, is a positional state of rotational engagement mechanism in which corresponding locking features of a first container and a second container are axially alignable but not rotationally secured. In one or more embodiments, open configuration 320 may include containers that may be freely separated by axial movement without overcoming a rotational retention constraint. In one or more embodiments, in open configuration 320, a projection, lug, or protrusion of first container may be aligned with an axial entry slot of second container 328. In one or more embodiments, in open configuration 320, circumferential locking channels may not yet be engaged, and no axial preload or cam-induced compression may be generated between the containers. In one or more embodiments, open configuration 320 may correspond to a relative rotational orientation defined within ±5 degrees of a designated alignment position that permits disengagement. In one or more embodiments, gravitational stacking alone may maintain the containers in a nested arrangement while remaining in open configuration 320, without producing mechanical interlock. “Closed configuration,” as used in this disclosure, is a positional state of rotational engagement mechanism in which corresponding locking features of a first container and a second container are rotationally displaced from the open configuration and mechanically interlocked. In one or more embodiments, closed configuration 324 may restrict axial separation without reverse rotation. In one or more embodiments, in closed configuration 324, a projection or lug may be rotated from an axial entry slot into a circumferential locking channel, such that an overhanging surface, stop surface, or cam surface prevents direct axial withdrawal. In one or more embodiments, closed configuration 324 may be achieved after a predefined angular displacement between 10 degrees and 90 degrees relative to open configuration 320. In one or more embodiments, closed configuration 324 may generate axial preload through interaction with a ramped, inclined, or helical cam surface. In one or more embodiments, closed configuration 324 may include one or more detent features configured to provide tactile or audible feedback indicating that a fully locked state has been reached. In one or more embodiments, closed configuration 324 may include rotational stop surfaces configured to limit further angular travel and define a repeatable end-of-rotation position. In one or more embodiments, transition from closed configuration 324 to open configuration 320 may require application of a reverse rotational torque exceeding a predefined threshold. In an embodiment, rotational engagement mechanism 316 may include the bayonet lock feature as described herein. As used in this disclosure, a "bayonet lock feature" is a mechanical fastening mechanism including interlocking elements that enable secure engagement and disengagement between two components. Bayonet lock feature may include one or more protrusions, pins, lugs, or tabs formed on a first container and one or more corresponding slots, grooves, channels, or cam paths formed on a second container 328, wherein protrusions are inserted into corresponding slots and subsequently rotated into a locked position. Rotation may cause the protrusions to translate axially along cam path of slot, thereby drawing the containers into a secured, retained configuration. The bayonet lock feature typically includes a protrusion or pin on one component and a corresponding slot or groove on the other, wherein the protrusion is inserted into the slot and rotated into a locking position. The bayonet lock feature may provide quick, tool-free locking or unlocking while providing reliable alignment and stability. In one or more embodiments, bayonet lock feature may be configured as a quarter-turn lock, half-turn lock, or multi-position rotational lock, depending on angular displacement required to achieve full engagement. In one or more embodiments, bayonet lock feature may include detents, stops, ramps, or shoulders that define discrete rotational positions corresponding to unlocked, partially engaged, and fully locked states. In one or more embodiments, bayonet lock feature may incorporate resilient or compliant elements, such as flexible tabs or spring-biased protrusions. In one or more embodiments, friction-enhancing surface textures or coatings may be applied to mating bayonet surfaces to increase rotational holding torque. With continued reference to FIG. 3A, the container body may be constructed from a metal material. With continued reference to FIG. 3A, the container body may include a coating material applied to the body wall 312. This may be implemented as described and with reference to FIGS. 1A-2C.

With continued reference to FIG. 3A, the at least a rotational engagement mechanism 316 includes an open configuration 320 and a closed configuration 324, wherein the rotational engagement mechanism is configured to lock the single use container 302 into a second container 328 by engaging with a corresponding feature on second container 328 when the rotational engagement mechanism is rotated into the closed configuration. At least a rotational engagement mechanism 316 may operate by engaging with a corresponding feature on second container 328 when the rotational engagement mechanism is rotated into the closed configuration. The rotation may allow the engagement of complementary features, such as tabs, slots, or ridges, thereby creating a secure connection between the containers. In one or more embodiments, corresponding feature associated with the rotational engagement mechanism 316 may be structurally and functionally distinct from a corresponding feature used in an axial interference-fit mechanism described elsewhere in this disclosure. In particular, whereas an interference-fit corresponding feature may rely primarily on radial dimensional overlap and elastic deformation to achieve retention, corresponding feature for the rotational engagement mechanism 316 may be configured to convert rotational motion into mechanical interlock. In one or more embodiments, corresponding feature for the rotational engagement mechanism 316 may include one or more circumferential locking channels, L-shaped slots, helical cam tracks, or rotational detent recesses formed on second container 328, wherein such features are configured to receive projections, lugs, tabs, or cam followers disposed on single use container 302. In one or more embodiments, corresponding feature may include an undercut surface or overhanging ledge positioned circumferentially relative to an axial entry opening, such that axial withdrawal is prevented unless reverse rotation is first applied. In one or more embodiments, corresponding feature for at least a rotational engagement mechanism 316 may extend circumferentially along a defined arc segment of second container 328, rather than forming a purely radial recess. In one or more embodiments, corresponding feature may include a continuous annular cam track extending around an entire periphery of second container 328. In one or more embodiments, corresponding feature may include multiple discrete circumferentially spaced slot segments, each configured to engage a respective projection of the rotational engagement mechanism 316. In one or more embodiments, engagement between at least a rotational engagement mechanism 316 and its corresponding feature may produce axial clamping force as a result of cam interaction, rather than purely frictional retention.

With continued reference to FIG. 3A, at least a rotational engagement mechanism 316 may include tabs and slots, wherein the tabs and slots are configured to interlock the single use container 302 with a second container 328 using rotational motion. As used in this disclosure, a "tab" is a protruding feature on a component, designed to fit into a corresponding receptacle. In one or more embodiments, corresponding receptacle may include a slot, to facilitate alignment, assembly, or interlocking of two or more components. The tab may extend outward from a surface and may have various shapes, such as rectangular, circular, or keyed, depending on the intended application. As used in this disclosure, a "slot" is a recessed or cut-out feature in a component, configured to receive a corresponding tab. In a non-limiting example, the tab may include a rectangular shape with dimensions of approximately 3 mm in width, 1.5 mm in height, and 0.5 mm in thickness, designed to fit onto a compact component like a single use container 302. Without limitation, the tab may include a semi-circular protrusion with a diameter of about 2 mm and a thickness of 0.5 mm, tailored to interface with a matching slot. In another non-limiting example, the slot may be a narrow rectangular groove with dimensions of 4 mm in length, 2 mm in width, and 1 mm in depth, intended to securely receive a small tab. Additionally and or alternatively, the slot may be shaped as a shallow circular indentation with a diameter of approximately 2.5 mm and a depth of 0.7 mm, accommodating a rounded tab for precise alignment or secure engagement. In another non-limiting example, the slot may be a straight rectangular groove with dimensions of 12 mm in length, 6 mm in width, and 3 mm in depth, configured to securely accommodate a rectangular tab. Additionally and or alternatively, the slot may include a keyed or T-shaped geometry, such as 15 mm in length, 8 mm in width at its widest section, and a depth of 4 mm, allowing for a specialized tab shape to provide enhanced locking or alignment functionality. The tab may be located near the opening end of the container to facilitate alignment during sealing or engagement, or near the closed end 308 to assist with secure placement or structural support. The slot may also be positioned near the opening end of the container to interact with a sealing mechanism or near the closed end 308 to enhance stability or positioning.

Now referring to FIG. 3B, an exemplary illustration 300b of a top isometric view of a container with a bayonet lock feature. This may be implemented as described and with reference to FIGS. 1A-3A. In one or more embodiments, top isometric view may illustrate spatial arrangement of one or more protrusions, pins, lugs, or tabs disposed circumferentially about open end 304 of container body, which are configured to cooperate with corresponding slots, grooves, channels, or cam paths formed on a mating container. In one or more embodiments, bayonet lock feature may be disposed along a rim portion of open end 304 and may project radially outward or inward relative to a central longitudinal axis of container. In one or more embodiments, slot geometry may include an entry region extending substantially parallel to the longitudinal axis to receive the protrusion, followed by a curved or angled cam path configured to convert rotational motion into axial displacement. In one or more embodiments, bayonet lock feature may be configured as a quarter-turn lock requiring approximately 90 degrees of rotation to transition from an unlocked to a fully locked position. In other embodiments, bayonet lock may require less than or greater than 90 degrees of rotation, including half-turn or multi-position rotational engagement configurations. In one or more embodiments, resilient or compliant elements, such as flexible tabs or spring-biased protrusions, may be incorporated into bayonet lock feature to accommodate manufacturing tolerances and to generate a preload force once the protrusion reaches a terminal locking position. In one or more embodiments, friction-enhancing surface textures, coatings, or micro-ridges may be formed along the mating bayonet surfaces to increase frictional retention and reduce the likelihood of unintended disengagement during handling or transport.

Now referring to FIG. 3C, an exemplary illustration 300c of a side view of two containers with bayonet lock features, wherein the two containers are in a locked position. This may be implemented as described and with reference to FIGS. 1A-3B. In one or more embodiments, locked position, one or more protrusions, pins, lugs, or tabs disposed on a first container may be fully inserted into corresponding slots, grooves, channels, or cam paths formed on a second container 328 and may have been rotated to a terminal locking position. Following axial insertion, relative rotational displacement between containers may cause protrusions to travel along a curved or angled cam path, thereby translating rotational motion into axial draw-in movement. As a result, containers may be drawn toward one another along a central longitudinal axis, creating compressive engagement at the stacking interface and establishing mechanical retention. In one or more embodiments, locked position may correspond to a rotational displacement of less than 180 degrees, including quarter-turn or half-turn configurations, wherein rotation may terminate at a stop, shoulder, or detent formed along cam path. In one or more embodiments, bayonet lock feature may generate both axial retention forces and rotational constraint, thereby resisting separation along the longitudinal axis and resisting reverse rotational movement absent application of a deliberate unlocking torque. In one or more embodiments, resilient or compliant elements integrated into protrusion or slot geometry may generate a preload force once terminal position is reached, increasing frictional engagement and rotational holding torque. Unlike an unlocked or passively nested condition, locked position may require intentional rotational force applied by a user. In one or more embodiments, locked configuration may additionally provide improved alignment of body wall 312 and load transfer between containers, enabling bayonet lock feature to function as both a mechanical connector and a stabilizing structure within a stacked assembly.

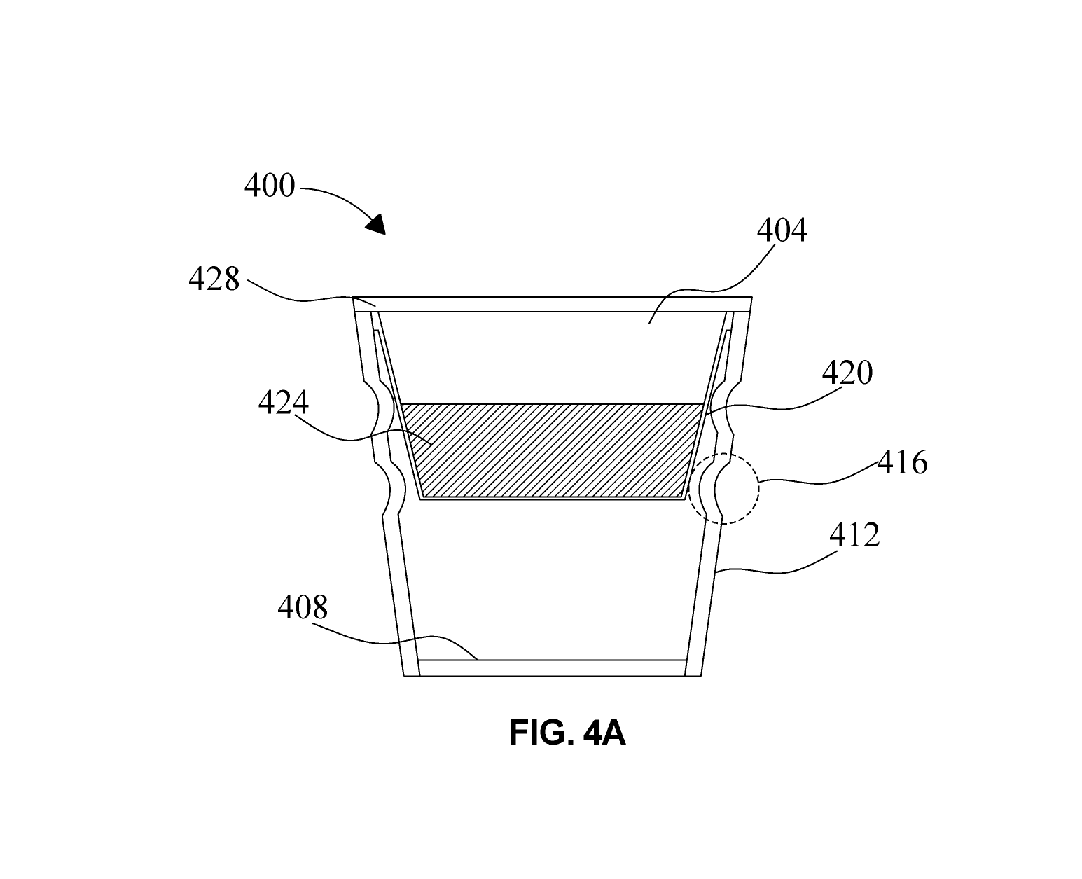

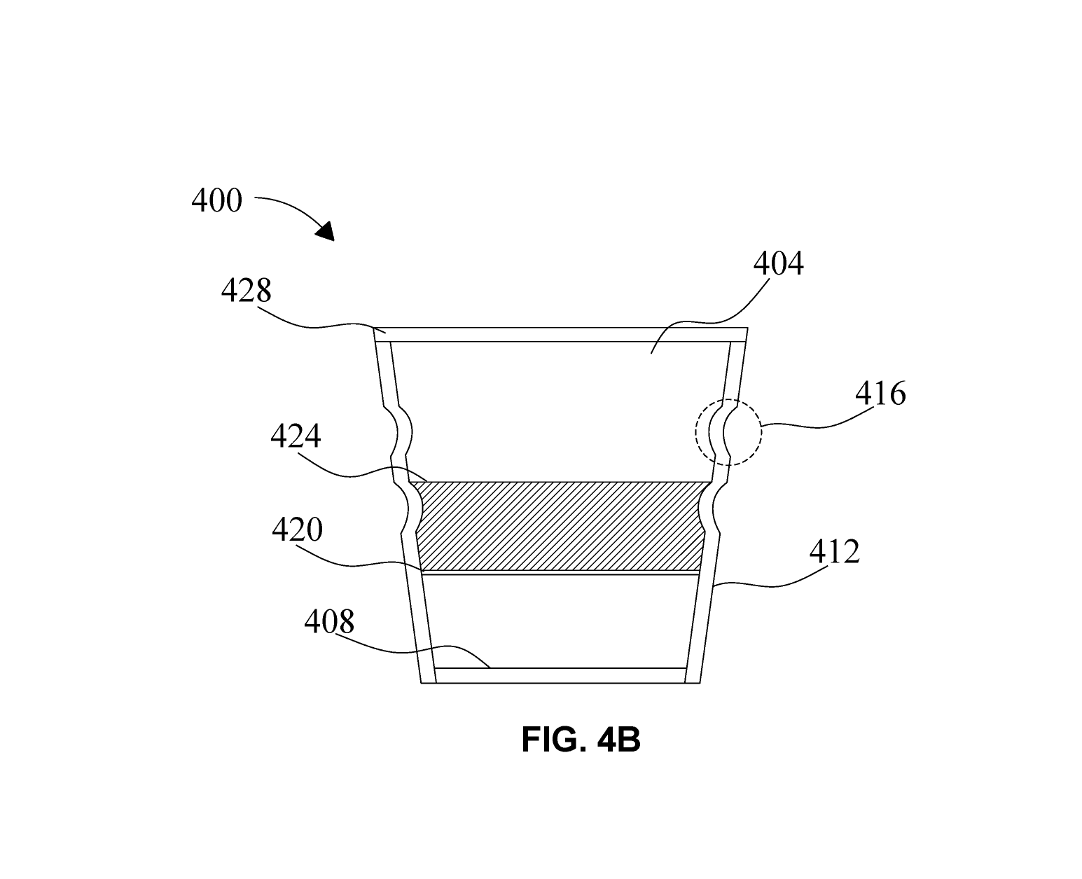

FIGS. 4A-B, cross-sectional views of exemplary embodiments of a single use container 400 is illustrated. In one or more embodiments, single use containers may include containers used in a brewing system. In a non-limiting embodiment, single use container 400 may include any single use container as described in U.S. Patent Application No. 18/603,527, filed on March 13, 2024, entitled as “DEVICE FOR SECURELY HOLDING SINGLE-USE CONTAINERS AND A METHOD OF RECYCLING SINGLE-USE CONTAINERS,” issued as patent No. 12,151,402 on November 26, 2024, the entirety of which is incorporated herein by reference. Exemplary embodiments of single use container 400 and components thereof are described below in further detail.

Now referring to FIG. 4A, single use container 400 includes a container body. As used in this disclosure, the main structural component that provides the shape and enclosure for the contents within single use container 400. Container body includes an open end 404, a closed end 408, and a body wall 412. In a non-limiting example, open end 404 may include a top opening or aperture through which the contents, such as, without limitation, ground substance, at least a fluid, and/or the like as described below, are inserted into the container body.

Still referring to FIG. 4A, as defined herein, the closed end 408, in some cases may include a sealed or enclosed portion of container body of single use container 400 that prevents contents from spilling or escaping. In a non-limiting example, closed end 408 may be the bottom of the single use container 400. In some cases, closed end 408 may be formed through a sealing process to securely enclose the contents within container body. In an embodiment, closed end 408 and body wall 412 may be continuous. In another embodiment, closed end 408 may incorporate additional layers or materials to provide enhanced strength and integrity; for instance, and without limitation, closed end 408 may include a separate bottom plate sealed to the bottom of body wall 412. In some cases, closed end 408 may be designed to withstand the pressure and heat generated during the brewing process without compromising the structural integrity of the single use container 400.

Still referring to FIG. 4A, in some cases, body wall 412 may include various features or characteristics. In a non-limiting example, body wall 412 may include a tapered design. Body wall 412 may gradually narrows from open end 404 towards closed end 408, wherein open end 404 includes a larger diameter compared to closed end 408. In some cases, body wall may include different thickness (e.g., 0.3mm ~1.2mm). Thickness may be determined based on the specific material used to construct body wall 412. Exemplary embodiments of material used by single use container 400 are described in further detail below.

In a non-limiting example, and still referring to FIG. 4A, container body may be a casing (i.e., outer shell) of content including other internal components of single use container 400 as described below. Container body of single use container 400 may be constructed from various materials. In a non-limiting example, container body may be constructed entirely or primarily from a metal material, such as aluminum material, wherein the aluminum is a lightweight and durable metal known for its corrosion resistance and thermal conductivity. In another non-limiting example, container body may be constructed from a cellulosic material. As used in this disclosure, a “cellulosic material” is any material derived from plant cells, specifically from cellulose, a complex carbohydrate that is the main constituent of the plant cell wall. For example, and without limitation, container body may include paper-based or fiber-based container body, wherein such cellulosic materials may be used as a biodegradable alternative to traditional plastic or aluminum. In some cases, cellulosic material may be molded (by breaking down cellulose fibers and reconstituting them in a form that can be molded) into desired shape of container body (e.g., circular shape, cylindrical shape, and/or the like).

Still referring to FIG. 4A, in some cases, paper-based or fiber-based container body may not have the necessary strength and durability depending on the use of single use container in its regular form; therefore, container body made from such cellulosic materials may be coated or treated with a coating material to enhance their properties. Coating material may include one or more food-grade coatings. In a non-limiting example, coating material may include wax. A thin layer of may be applied to at least a surface (e.g., inner surface) of body wall to provide moisture resistance and improve the barrier properties (i.e., leak-proof). In another non-limiting example, for single use container 400 with aluminum container body, epoxy resin may be used to coat container body by create a protective barrier between the aluminum surface and ground substance and/or at least a fluid, preventing direct contact and minimizing the risk of any unwanted reactions between the beverage and the aluminum container body. Such coating may provide a durable and chemically resistant barrier that helps prevent corrosion and protect the beverage from any metallic taste or contamination. Other exemplary food-grade coatings may include, without limitation, lacquers, polymer-based coatings, and/or the like.

With continued reference to FIG. 4A, body wall includes at least an alignment feature 416. As used in this disclosure, an "alignment feature" is a physical feature that helps to precisely align, interface, or couple one component with one or more other components. In a non-limiting example, at least an alignment feature 416 may be located on the outer surface and/or inner surface of body wall 412 and is configured for precise guiding, positioning and securing single use container to a second single use container. At least an alignment feature 416 may include, without limitation, one or more physical notches and/or grooves, one or more optical markers or alignment indicators that are visible (through human eye, microscope, any other imaging system, and/or the like), one or more tapered or angled surfaces (of body wall 412) that guide the one or more surfaces of adjacent single use container (i.e., second single use container).

In a non-limiting example, and still referring to FIG. 4A, at least an alignment feature 416 may include a second at least an alignment feature corresponding to the at least an alignment feature 416. In some cases, at least an alignment feature 416 may include a male and/or a female alignment feature, wherein the male/female alignment feature may be favorably interfaced with female/male alignment feature. For example, and without limitation, container body of single use container 400 may include a body wall having a plurality of grooves, wherein each groove may include an outer surface (i.e., hollowed-out surface) as female/male alignment feature and an inner surface (i.e., protruding surface), opposite to the outer surface as male/female alignment feature. Female/male alignment features on the outer surface of body wall 412 of single use container 400 may align with interior surface of body wall of second single use container and lock single use container 400 to second single use container by interfacing with male/female alignment features on the internal surface of body wall of second single use container, if single use container 400 is inserted into second single use container through second single use container’s open end.

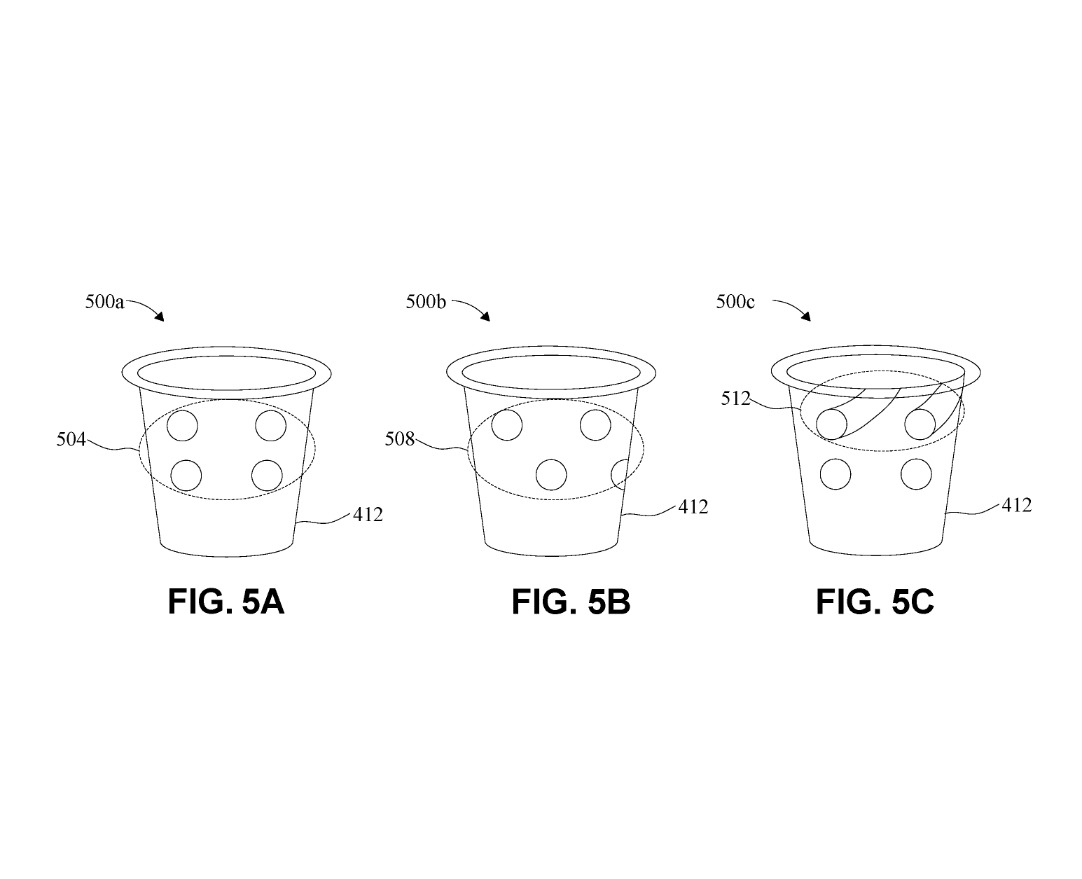

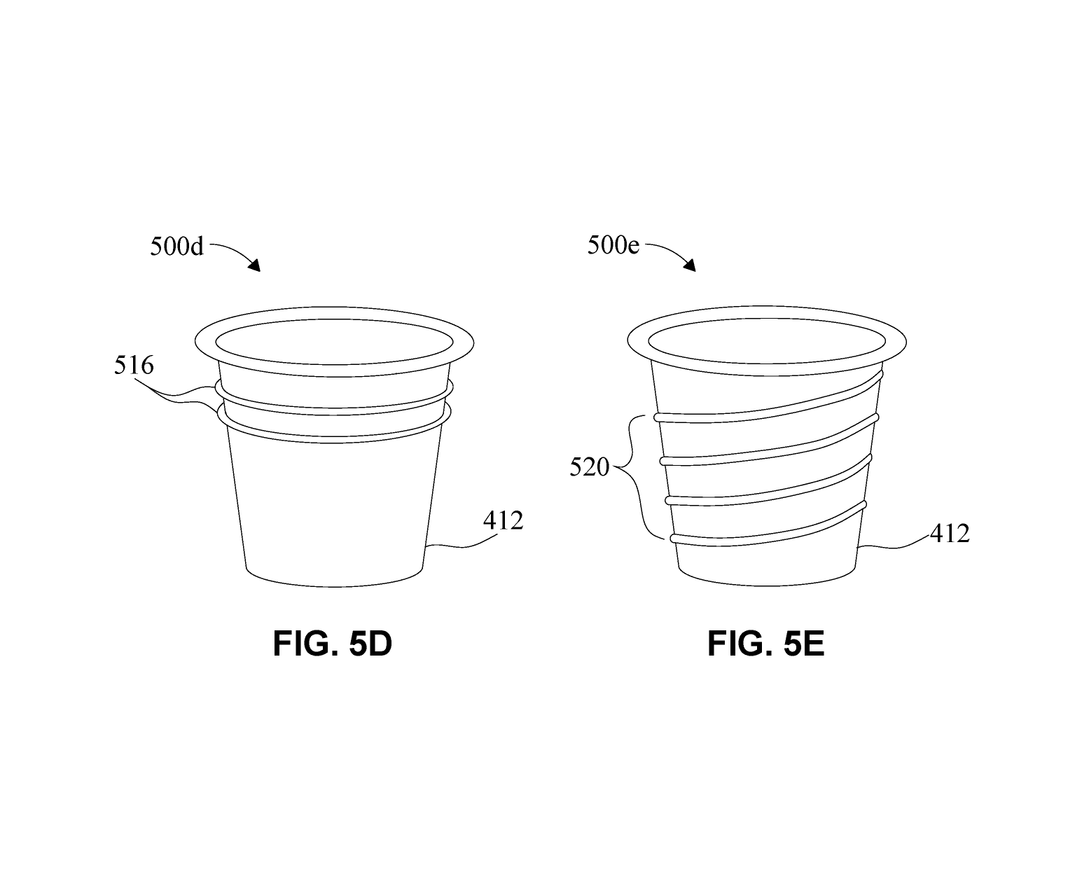

Additionally, or alternatively, and still referring to FIG. 4A, at least an alignment feature 416 may be configured to guide single use container 400 into a correct position in a machine (i.e., beverage machine). In an embodiment, such at least an alignment feature may ensure that single use container 400 is properly oriented for the brewing process. In a non-limiting example, open end 404 of container body may include at least an alignment feature such as a rim or a ridge that aligned with a corresponding rim or ridge inside the machine to secure inserted single use container 400 and forming a leak-proof closure. Exemplary embodiments of at least an alignment feature 416 are described in further detail with reference to FIGS. 5A-E.

With continued reference to FIG. 4A, container body includes a filter medium 420, wherein the filter medium 420 is configured to contain a ground substance 424. As used in this disclosure, a “filter medium” is a material used to separate ground substance 424 from at least a fluid as it flows towards closed end 408. A “ground substance,” for the purpose of this disclosure, refers to the finely ground ingredients. In some cases, ground substance 424 may include, without limitation, coffee grounds, tea grounds, tea leaves, and any other substance that gives flavor and aroma to the brewed beverage. In some cases, filter medium 420 may be formed from a biodegradable material. In other cases, filter medium 420 may include a permeable material; for instance, and without limitation, filter medium may include a plurality of apertures that are small enough to retain solid particles (e.g., ground substance 424) but large enough to allow at least a fluid to diffuse therethrough. In a non-limiting example, filter medium may include a paper or a non-woven fabric that has been treated or processed to have such permeable properties.

Still referring to FIG. 4A, in an embodiment, filter medium 420 may be attached (i.e., glued) to the wall of the container body using a safe, food-grade adhesive. In another embodiment, the filter medium may be attached (i.e., sealed) to the open end 404 of container body, or body wall 412 through a heat-sealing process. In such embodiments, filter medium 420 may be configured to separate single use container into two chambers. In a non-limiting example, filter media 420 may be configured to separate the container body into a first chamber and a second chamber, wherein the first chamber is configured to contain ground substance 424 and the second chamber is configured to contain the at least a fluid. In some cases, at least a fluid may be air before the use of single use container 400. In other cases, at least a fluid may be filtered fluid during or after the use of single use container 400 as described below.

Additionally, or alternatively, filter medium 420 may include a detachment mechanism configured to disengage filter medium 420 from container body. As used in this disclosure, a “detachment mechanism” is a design feature that allows filter media 420 to separate from the rest of single use container 400. In a non-limiting example, filter medium 420 may be held in place within container body by one or more mechanical feature that can be easily undone, such as snap fit or a tab that can be unhooked. In another non-limiting example, single use container 400 may include filter medium 420 that is secured to body wall with a water-soluble adhesive. After use, user may soak single use container 400 in water, causing the adhesive to dissolve and filter medium 420 to detach, allowing the user to compost ground substance and filter medium, while recycling the container body. In a further non-limiting example, filter medium 420 may include a smaller open container (i.e., smaller in diameter compared to open end 404 of container body) that locked into container body via tension fit. Such filter medium 420 may be separate from container body by applying a gentle but steady force in the direction that will disengage or separate filer medium 420 from container body. Further, filter medium 420 may be replaceable. In a non-limiting example, filter medium 420 may be removed from single use container 400 through open end 404 of container body and a new filter medium may be inserted into container body for a subsequent use.

With continued reference to FIG. 4A, a cover 428 sealed to open end 404 of container body. As used in this disclosure, a “cover” is a lid or sealing that is placed over open end 404 of container body. In an embodiment, cover 428 may be configured to keep ground substance 424 fresh and uncontaminated until it is time to brew. Cover 428 is configured to be punctured for the introduction of at least a fluid into container body. In a non-limiting example, cover 428 may provide a surface that can be punctured by one or more needles of brewing machine to allow hot water to enter single use container 400. In some cases, cover 428 may be made from a material that can be easily pierced but also strong enough to maintain the integrity and freshness of single use container during storage and handling. In some cases, material may also be heat-resistant. In a non-limiting example, cover 428 may include a foil lid that is heat-sealed to the rim (i.e., at least an alignment feature 416) of open end 404 of container body, wherein the foil lid is thin enough to be easily pierced by the brewing machine.

In one or more embodiments, and still referring to FIG. 4A, cover 428 may be configured to open and closed to allow user to add ground substance into container body manually. In a non-limiting example, single use container 400 may further include a hinged mechanism or articulated closure which allows cover 428 to be open and closed using a hinge or an articulated joint. Such functionality may also enable user to remove/replace filter medium as described above.

In a non-limiting example, and still referring to FIG. 4A, hot water may be injected into container body of single use container 400 and mixed with ground substance. At least a fluid may flow through filter medium 420 and towards closed end 408 of container body. In some cases, filter medium 420 may be arranged to enhance flow-through of the at least a fluid. In a non-limiting example, filter medium may be configured as an inverted cone.

With continued reference to FIG. 4A, closed end 408 is configured to direct a flow of the at least a fluid out of the container body. In some cases, closed end 408 may also be punctured, by the brewing machine, in addition to cover 428. At least a fluid such as hot water may be then forced into container body through one or more holes on cover 428, wherein the hot water may mix with ground substance such as coffee grounds (or other beverage ingredients) inside single use container 400. The resulting brew then flows out of the pod through one or more holes on closed end 408. In some cases, closed end 408 may be slightly convex or conical. Such design may ensure brewed beverage (i.e., filter fluid) flows out smoothly and does not spill or leak (by guide the fluid towards the punctured point. In other cases, closed end 408 may include a specially designed spout or nozzle configured to help direct the flow of the at least a fluid into another container (e.g., user’s cup).

Additionally, or alternatively, and still referring to FIG. 4A, closed end 408 may include a pressure-release feature. A “pressure-release feature,” for the purpose of this disclosure, is a device that allows single use container 400 to safely relieve or release pressure that builds up inside container body during the brewing process. In a non-limiting example, when hot water is forced into single use container 400, it mixed with ground substance 424 and create a certain amount of pressure inside container body. In some cases, too much pressure may cause single use container 400 to burst or leak. In some cases, closed end 408 may include a weak spot, wherein the “weak spot,” as described herein, is a specific area that is intended to rupture or open if the pressure inside container body becomes too high. In another non-limiting example, closed end 408 may include a pressure-activated valve, wherein the pressure-activated valve may be configured to open under a certain amount of pressure within container body.

Now referring to FIG. 4B, an exemplary embodiment of single use container 400 having filter medium 420 attached to body wall 412 of container body is illustrated. In an embodiment, filter medium 420 may be securely attached to the inside of body wall 412 instead of open end 404 sealed along with cover 428. Attachment of filter medium 420 may be accomplished through various method such as, without limitation, adhesive bonding, heat sealing, ultrasonic welding, or even mechanical fixtures. These methods for attaching filter medium 420 to inside of body wall 412 may not compromise the permeability of filter medium 420 and/or the integrity of single use container 400. In such embodiment, filter medium 420 may be disposed after alignment feature 416 (i.e., below alignment feature 416 as shown in FIG. 4B)

Now referring to FIGS. 5A-E, exemplary embodiments of alignment features are illustrated. In an embodiment, single use container 400 may include a plurality of alignment features located on the exterior and/or interior of container body (e.g., body wall 412). In some cases, at least an alignment feature 416 may be disposed on at least a surface of body wall 412 in an arrangement pattern. At least an alignment feature 416 may include one or more physical characteristics designed to facilitate insertion (e.g., stacking) of one or more single use container 400 in a precise and/or secure manner as described above with reference to FIG. 4A. As used in this disclosure, an “arrangement pattern” refers to a way in which one or more alignment features are laid out or organized on a surface or within a structure of single use container 400. In an embodiment, arrangement pattern of plurality of alignment features may impact the functionality, aesthetics, and usability of single use container 400.

In a non-limiting example, and referring to FIG. 5A, illustration 500a includes a plurality of alignment features may be arranged in a straight/aligned pattern 504. A “straight/aligned pattern” is an arrangement pattern in which the plurality of alignment features is arranged in vertical or horizontal straight line/lines on at least one surface of body wall 412. In a non-limiting example, plurality of alignment features may include a plurality of round/oval recesses along body wall 412, wherein the plurality of recesses is configured to interconnect and lock one another together when a plurality of single use containers is stacked within one another.

In another non-limiting example, and referring to FIG. 5B, illustration 500b includes a plurality of alignment features may be arranged in a staggered pattern 508. As used in this disclosure, a “staggered pattern” is an arrangement pattern in which the plurality of alignment features is offset or not directly aligned with each other. In an embodiment, rather than being placed directly in line or in parallel rows or columns like straight/aligned pattern 504 as described above with reference to FIG. 5A, plurality of alignment features is shifted or “staggered” relative to each other. In a non-limiting example, plurality of round/oval recesses are arranged in offset rows around the circumference of body wall 412, wherein the round/oval recesses in one row may be positioned in between round/oval recesses in the adjacent rows, rather than being directly aligned with them.

In another non-limiting example, and referring to FIG. 5C, illustration 500c includes one or more alignment features may be connected to form a combined alignment feature 512. In a non-limiting example, round oval recesses along body wall 412 may be combined with a curved channel/thread which when a plurality of single use containers are stacked, curved channels may enable the plurality of single use containers to be twisted or threaded within one another, thereby lock one another together.

Now referring to FIG. 5D, an alignment feature comprising a plurality of circumferential beads 516 is illustrated. As used in this disclosure, “circumferential beads” are raised lines or ridges (beads) are placed around the circumference of body wall. In some cases, plurality of circumferential beads may help single use container 400 resist deformation under load or pressure.

Now referring to FIG. 5E, an exemplary embodiment of an alignment feature comprising a plurality of channels/threads 520 is illustrated. In a non-limiting example, a continuous spiral or helical ridge (like a thread on a screw or bolt). Such alignment feature may start at one point on body wall 412, proximal to closed end 408, and climb/spiral upward around single use container 400 towards open end 404 or vice versa.

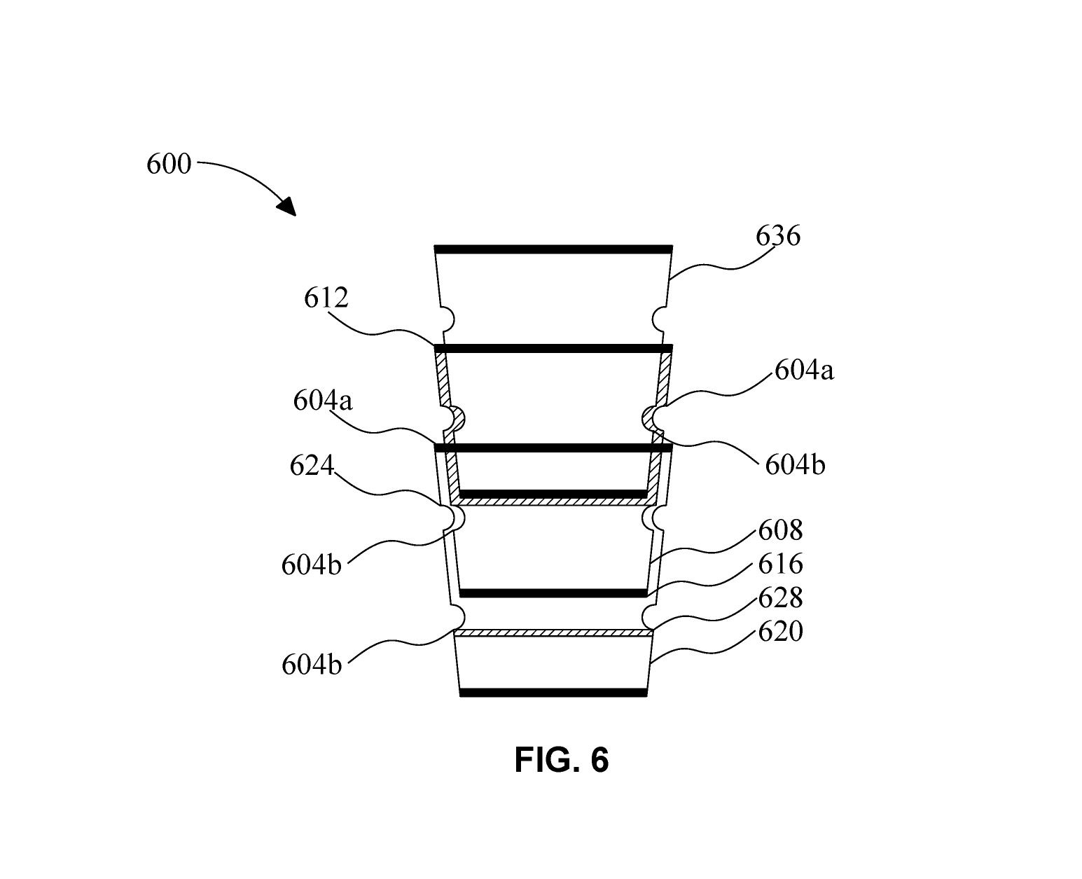

Now referring to FIG. 6, an exemplary embodiment of a plurality of interlocked single use containers 600 is illustrated. These containers, in some embodiments, may include those as discussed in connection with FIGS. 1A to 3C. Each single use container of plurality of interlocked single use containers 600 may include any single use container and components thereof as described above with reference to FIGS. 4A-5E. In some cases, each single use container may include a plurality of alignment features 604a-b. In a non-limiting example, plurality of alignment features 604a-b of a first single use container 608 may include a first alignment feature 604a and a second alignment feature, wherein the first alignment feature 604a may be located proximal to an open end 612 of the first single use container 608 and the second alignment feature 604b may be located proximal to an closed end 616 of first single use container 608. In some cases, plurality of alignment features 604a-b may be arranged in an arrangement pattern on the body wall of each single use container of plurality of single use containers; for instance, and without limitation, plurality of alignment features 604a-b may be arranged in a straight/aligned pattern 504 as described above with reference to FIG. 5A, wherein first alignment feature 604a and second alignment feature 604b are vertically aligned. Second alignment feature 604b may be positioned in certain distance (e.g., approximal to the distance between second alignment feature 604b and closed end 616) away from the first alignment feature 604a.

Still referring to FIG. 6, first single use container 608 may be inserted into a second single use container 620 through an open end 624 of the second single use container 620. Insertion of first single use container 608 to second single use container 620 may be secured via interfacing of first single use container’s second alignment feature 604b and second single use container’s first alignment feature 604a. In a non-limiting example, first alignment feature 604a of second single use container 620 may be “fit” into the second alignment feature 604b of first single use container 608. The shape of first alignment feature’s inner surface may match to the shape of second alignment feature’s outer surface such that first alignment feature 604a may be locked on second alignment feature 604b via a press fit. Additionally, or alternatively, closed end 616 of first single use container 608 may be structurally supported, by (the inner surface of) second alignment feature 604b of second single use container 620.

With continued reference to FIG. 6, filter medium may be attached to body wall of one single use container in a position that does not interfere with the insertion of another single use container. In a non-limiting example, second single use container 620 may include a filter medium 628 attached to the (inner surface of) body wall of second single use container 620 below second alignment feature 604b. Filter medium 628 may include any filter medium 628 as described above with reference to FIG. 4A. In a non-limiting example, first single use container 608 may include a filter medium 628 attached to open end 612 of first single use container 608. A third single use container 636 may be inserted into filter medium 628 through open end 612. Instead of first alignment feature 604a of first single use container directly contact with second alignment feature 604b of third single use container 636 to lock two single use containers, filter medium 628 may be sandwiched between inner surface of first single use container’s body wall and outer surface of third single use container’s body wall. In some cases, filter medium 628 may comply with alignment features and serve as a layer of reinforcement between first single use container 608 and third single use container 636. In some cases, filter medium 628 may also increase the friction between two single use containers (e.g., reducing in diameter of the open-end portion of first single use container 608), thereby providing additional stability.

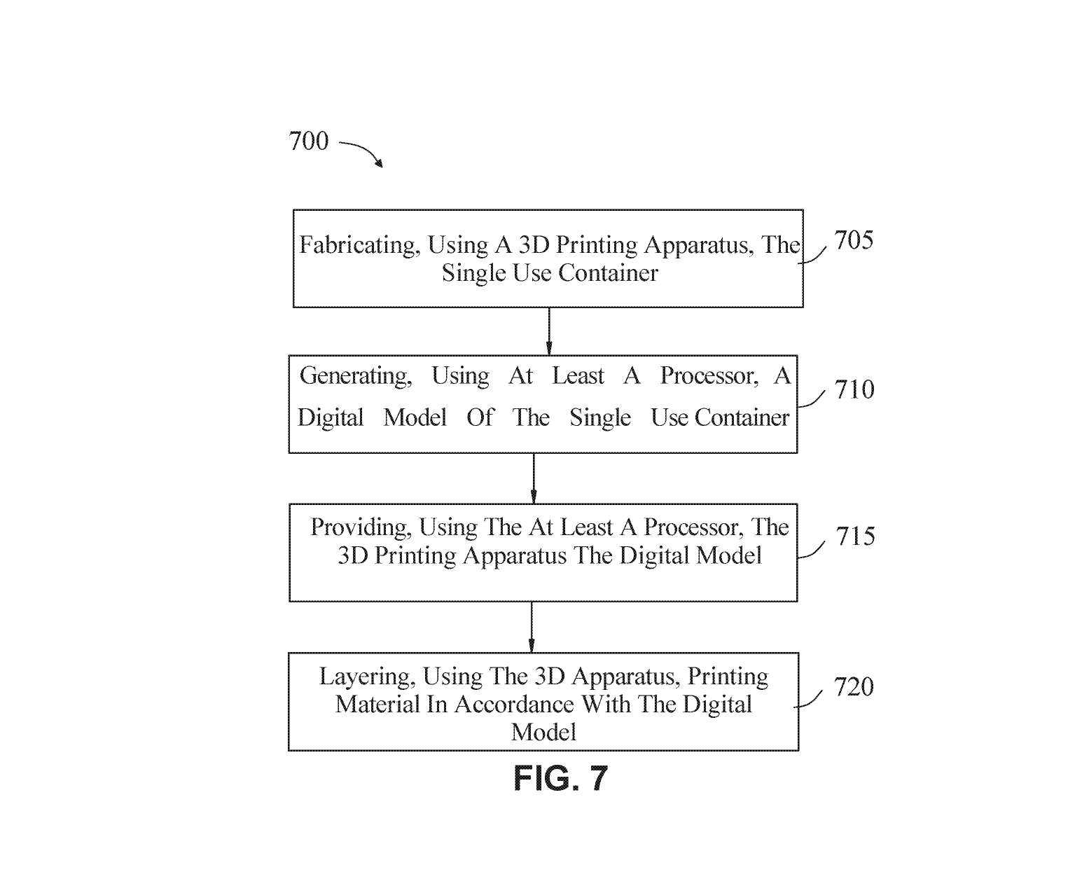

Referring now to FIG. 7, a flow diagram of an exemplary method 700 for manufacturing a single use container is illustrated. At step 705, method 700 includes fabricating, using a 3D printing apparatus, the single use container. This may be implemented as described and with reference to FIGS. 1-6.

Still referring to FIG. 7, at step 710, method 700 includes fabricating the single use container by generating, using at least a processor, a digital model of the single use container. In an embodiment, the printing material may include a biocompatible polymer. This may be implemented as described and with reference to FIGS. 1-6.

Still referring to FIG. 7, at step 715, method 700 includes fabricating the single use container by providing, using the at least a processor, the 3D printing apparatus the digital model. In an embodiment, the single use container may include a container body, wherein the container body comprises an open end, a closed end, a body wall between the open end and the closed end, and at least a locking feature, wherein the at least a locking feature is configured to lock the single use container into a second container by engaging with a corresponding feature on the second container. In an embodiment, the at least a locking feature may include one or more of a top lock feature, a bottom lock feature, and a rotational engagement mechanism. This may be implemented as described and with reference to FIGS. 1-6.

Still referring to FIG. 7, at step 720, method 700 includes fabricating the single use container by layering, using the 3D apparatus, printing material in accordance with the digital model. In an embodiment, the printing material may include a biocompatible polymer. This may be implemented as described and with reference to FIGS. 1-6.

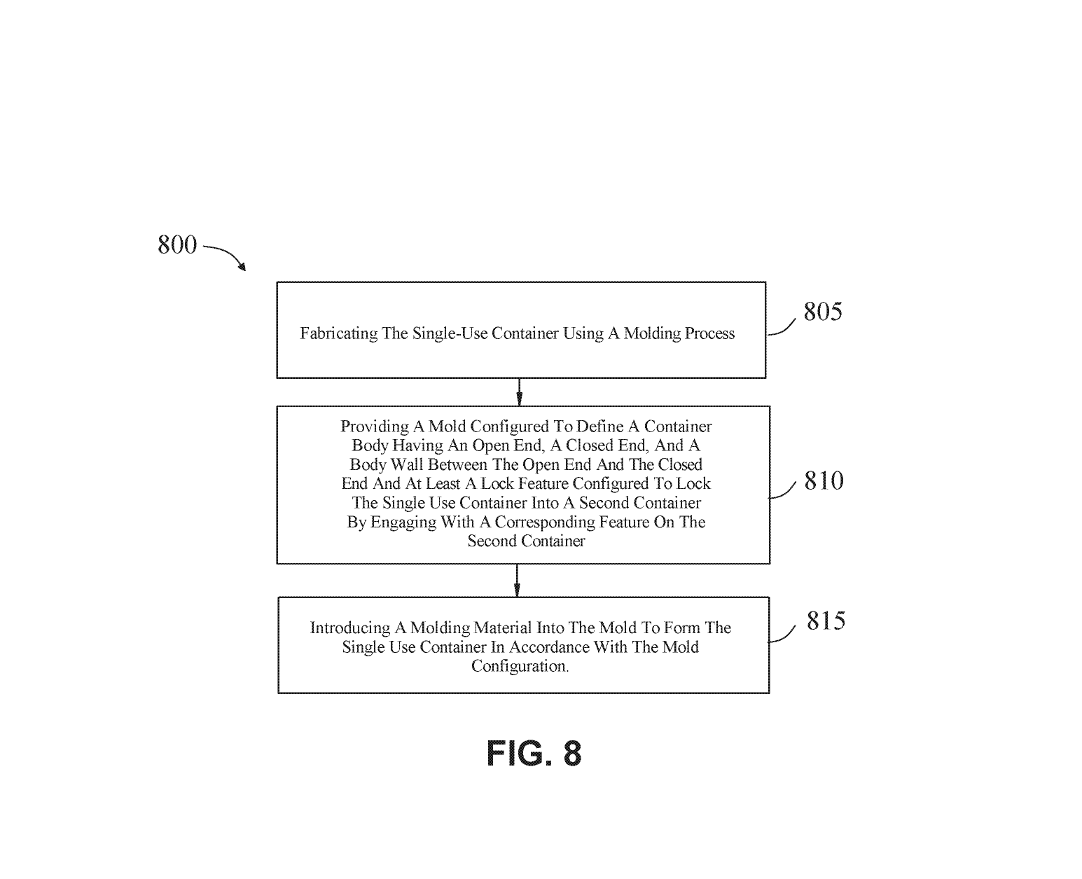

Referring now to FIG. 8, a flow diagram of an exemplary method 800 for manufacturing a single use container is illustrated. At step 805, method 800 includes fabricating the single use container using a molding process. This may be implemented as described and with reference to FIGS. 1-6.

Still referring to FIG. 8, at step 810, method 800 includes fabricating the single use container using a molding process by providing a mold configured to define a container body having an open end, a closed end, and a body wall between the open end and the closed end, and at least a lock feature configured to lock the single use container into a second container by engaging with a corresponding feature on the second container. In an embodiment, the at least a locking feature comprises one or more of a top lock feature, a bottom lock feature, and a rotational engagement mechanism. In an embodiment, wherein the container body may include a coating material applied to the body wall. This may be implemented as described and with reference to FIGS. 1-6.

Still referring to FIG. 8, at step 815, method 800 includes fabricating the single use container using a molding process by introducing a molding material into the mold to form the single use container in accordance with the mold configuration. In an embodiment, wherein the molding material may include a metal material. This may be implemented as described and with reference to FIGS. 1-6.

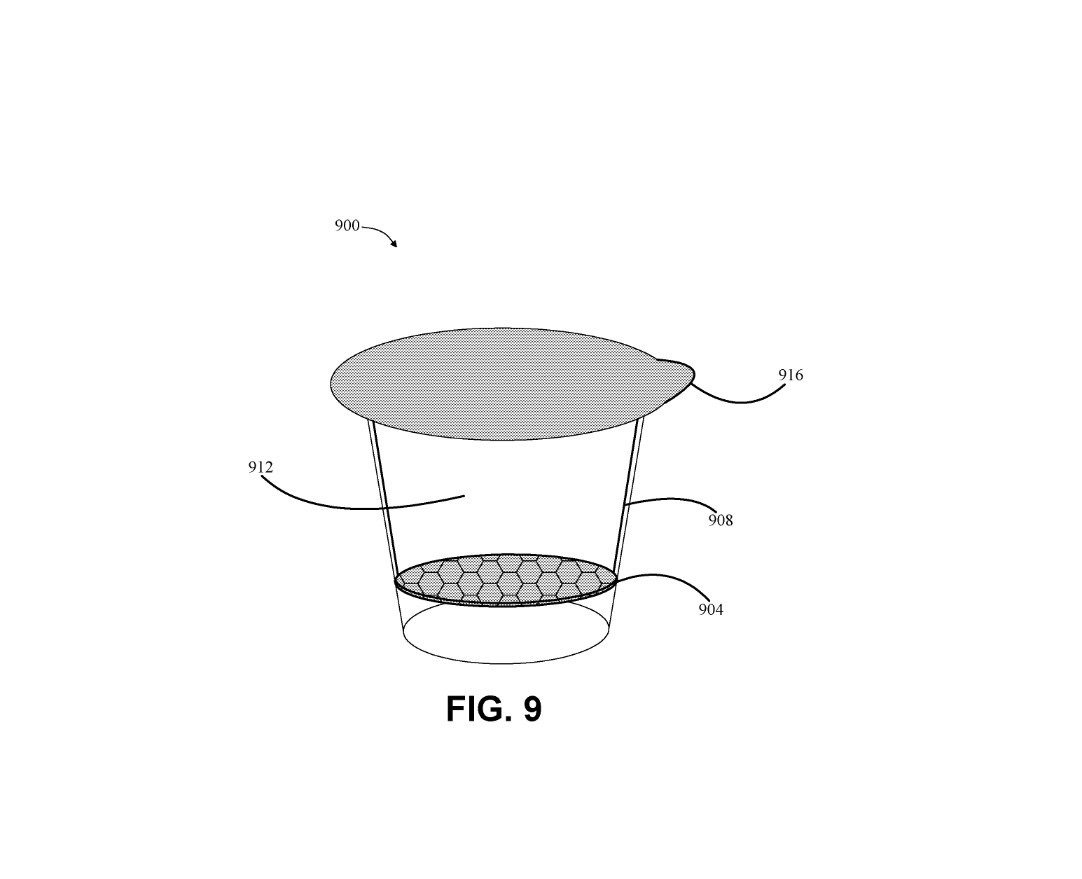

Now referring to FIG. 9, an exemplary embodiment of a beverage pod 900 is shown. Within this embodiment filter disc 904 is shown in an embodiment wherein the filter disc 904 is up off the floor of the interior floor of the cavity of the beverage pod 900. Additionally, shown is a formed filter material 908 adhered to the interior wall of the cavity of beverage pod 900. Furthermore, an area in which the beverage material 912 would fill is represented. In this embodiment, beverage material 912 is not present in order to showcase the other properties of beverage pod 900. Lastly, airtight lid 916 is pictured. In an embodiment airtight lid 916 may include a tab configured to enable a user to easily peal airtight lid 916 from beverage pod 900. Beverage pod 900 may include beverage pod characteristic as described in U.S. Nonprovisional Application No. 18/599,862, filed on March 8, 2024, and entitled “HIGHLY RECYCLABLE BEVERAGE PODS AND METHOD OF MANUFACTURE,” and having attorney docket no. 1326-003USU1.

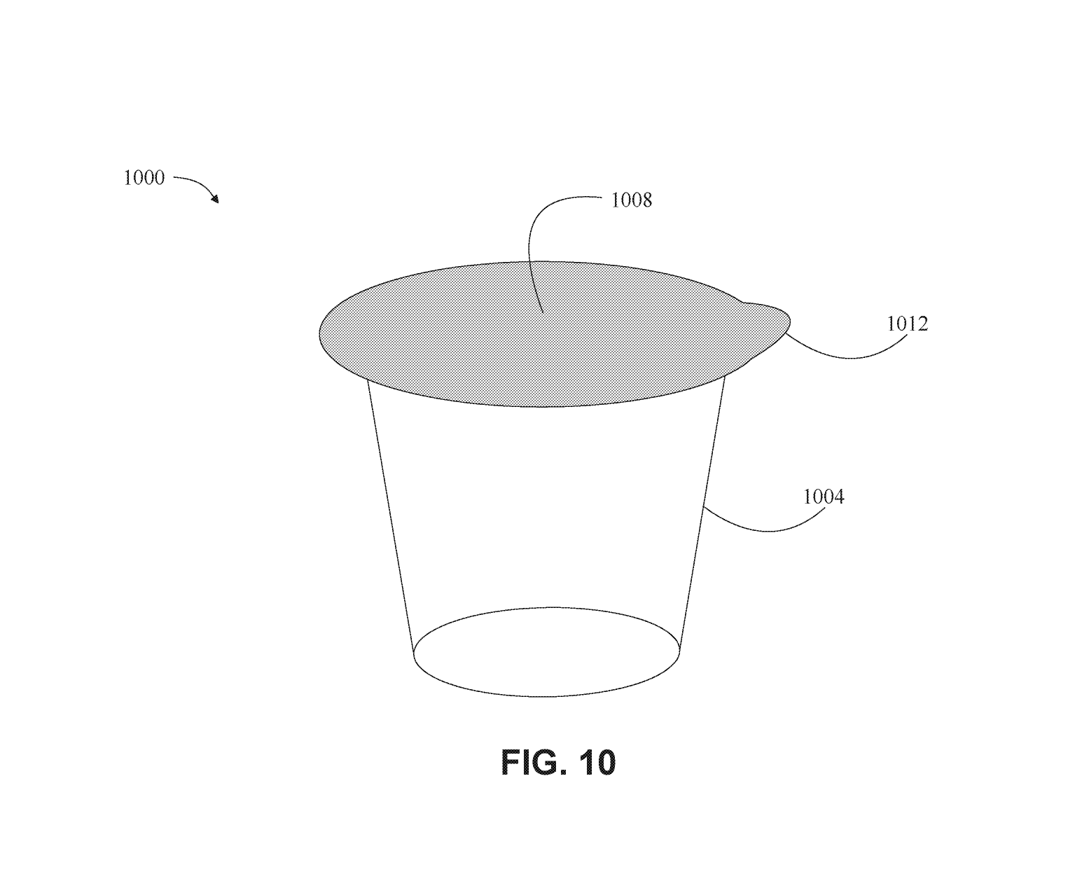

Now referring to FIG. 10, a nonlimiting particular embodiment of a peelable lid with a frangible seal is shown. A peelable lid with a frangible seal may include container body 1004, lid 1008, and pull tab 1012. These components may include any embodiments discussed throughout this disclosure and any disclosure here within incorporated by reference. “Frangible seal,” as used in this disclosure, is a breakable sealing interface disposed between a lid and a container body. In one or more embodiments, frangible seal may include breakable sealing interface being configured to maintain a closed, leak-resistant condition during storage and transport and to irreversibly separate upon application of a user-applied peeling force exceeding a predefined separation threshold.

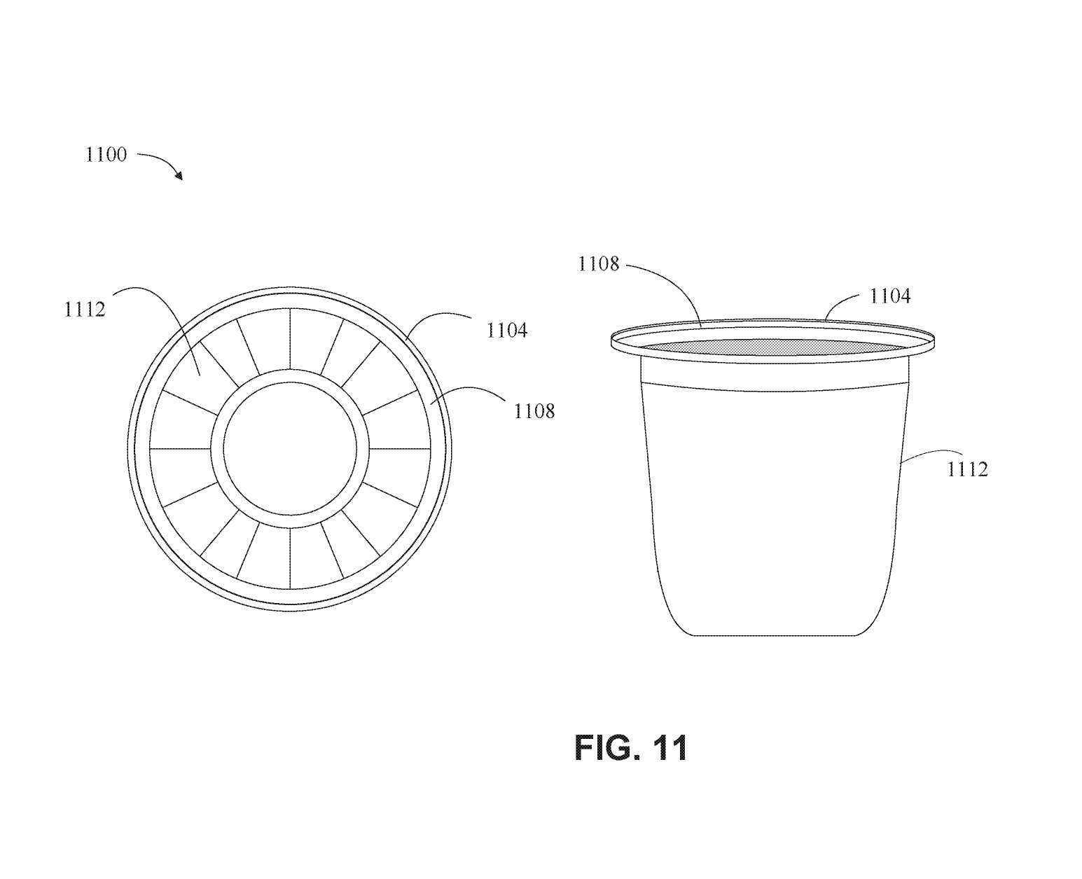

Now referring to FIG. 11, a particular embodiment of a container body is shown. Illustrated is a top-down view aside a side profile view of the particular embodiment of a container body. In this particular embodiment the rim of a container body may include more than a single rim. As pictured in the particular implementation a first, smaller rim 1104 is situated in a way that protects the second, larger in width rim 1108. Note, how this particular implementation may provide a safe guard to the frangible seal by having a first raised rim 1104 that is configured to protect the second rim 1108 which is recessed on the vertical plane from the first rim 1104. Depicted for ease of viewing is wall of container body 1112. In some embodiments, wherein a polymer layer and/or an adhesive is used on the rim of the container body, second rim 1108 may be the area where this is applied.

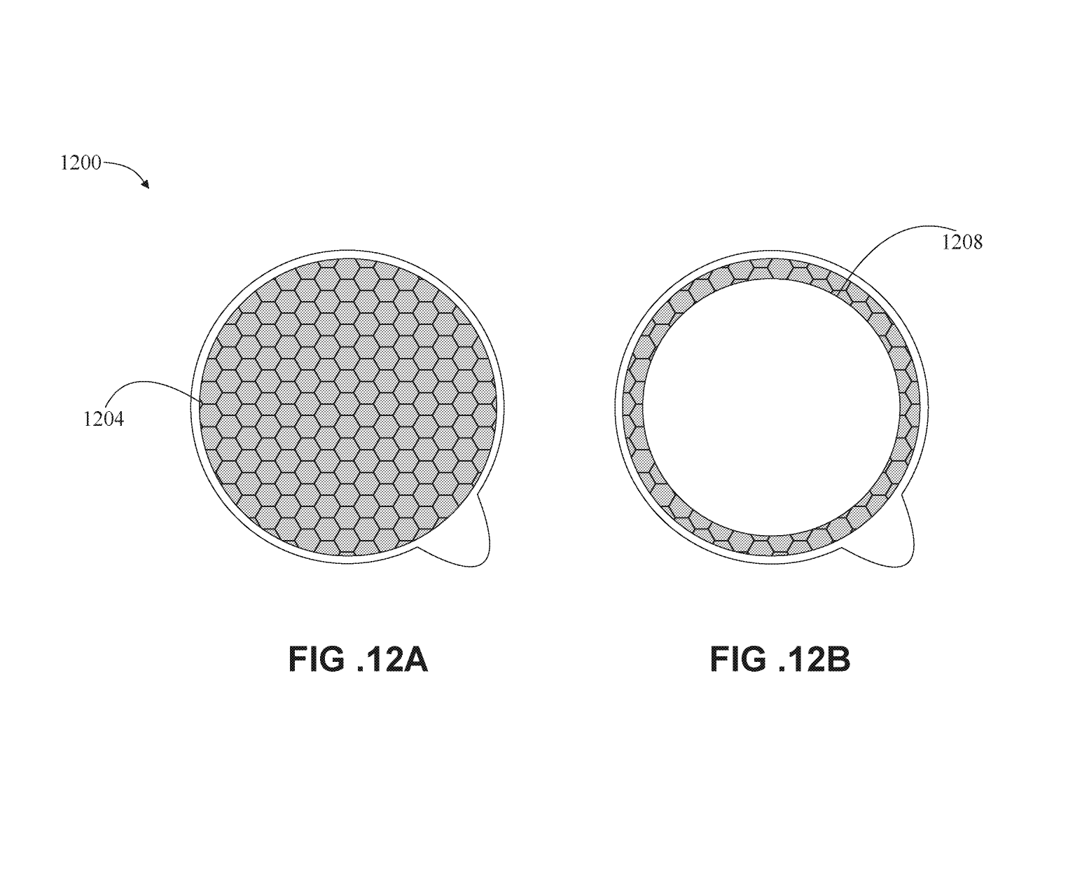

Now referring to FIG. 12A and 12B, particular embodiments and placement of adhesives and/or polymer layers are illustrated. In a nonlimiting embodiment, adhesive/polymer layer 1204 covers the entirety of the underlying lid. Other embodiments may have no surrounding edge and/or a larger surrounding edge as pictured in FIG. 12A. Furthermore, some embodiments, such as the adhesive/polymer layer 1208 may create a pattern that coincides with the shape and/or dimension of the corresponding rim of the container body. This may include an embodiment as pictured and/or any embodiment as described throughout this disclosure. For example, and without limitation, the underside of the lid may include no additional adhesive and/or polymer layer. Layer meaning either lining and/or coating depending on the application thereof. Polymer layers may be in different thicknesses across any embodiment of the lid and/or rim. In reference to FIG. 12B, further exemplary embodiments may include a lid with an underside having a polymer layer having a different thickness in comparison to the thickness of the rim and/or interior body wall. These embodiments and configurations are nonlimiting and may be substituted with any description as used throughout this disclosure. Additionally, thicknesses are shown not necessarily to scale, but to visually depict the difference between the thicknesses. Lid polymer layer 1212 is shown in combination with rim polymer layer 1216 and container body wall polymer layer 1220. In some embodiments, there may be a thicker lid polymer layer 1224 in comparison to the lid polymer layer and the container body wall polymer layer 1228. Further, in some embodiments, the rim polymer layer 1232 may be thicker than the lid polymer layer and the container body polymer layer 1236. In some embodiments container body wall polymer layer may be thicker than both the lid polymer layer and/or the rim polymer layer. This may be so, in part, because of the purpose of each layer. Because the frangible seal depends on the polymer layers of the lid and/or rim these layers may be thinner in comparison to the container body wall polymer layers.

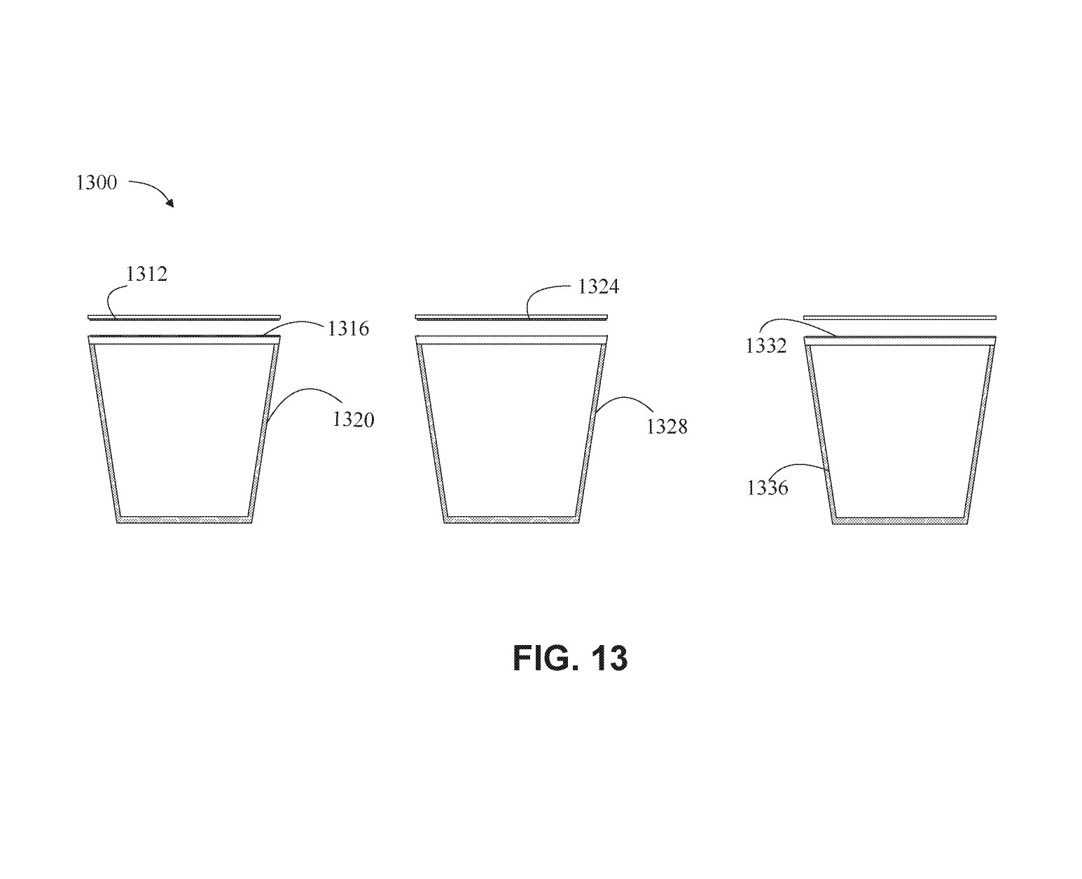

Now referring to FIG. 13, particular embodiments of a pull tab are illustrated. Pull tab 1304 illustrates an embodiment wherein the pull tab is included in the embodiment of the lid. Alternatively, lid 1308 illustrates pull tab 1312, wherein the pull tab exists separately from lid 1308. This configuration illustrates an embodiment where pull tab 1312 extends across the length of lid 1308. Lastly, lid 1316 illustrates pull tab 1320 which is configured in a pattern that may match up with a corresponding rim of a container body. These components may include any embodiments discussed throughout this disclosure and any disclosure here within incorporated by reference. Containers described in FIG. 10 to FIG. 13 may include characteristic as described in U.S. Nonprovisional Application No. 18/606,085, filed on March 15, 2024, and entitled “METHOD OF MANUFACTURE FOR A HIGHLY PEELABLE LID WITH A FRANGIBLE SEAL,” and having attorney docket no. 1326-005USU1.

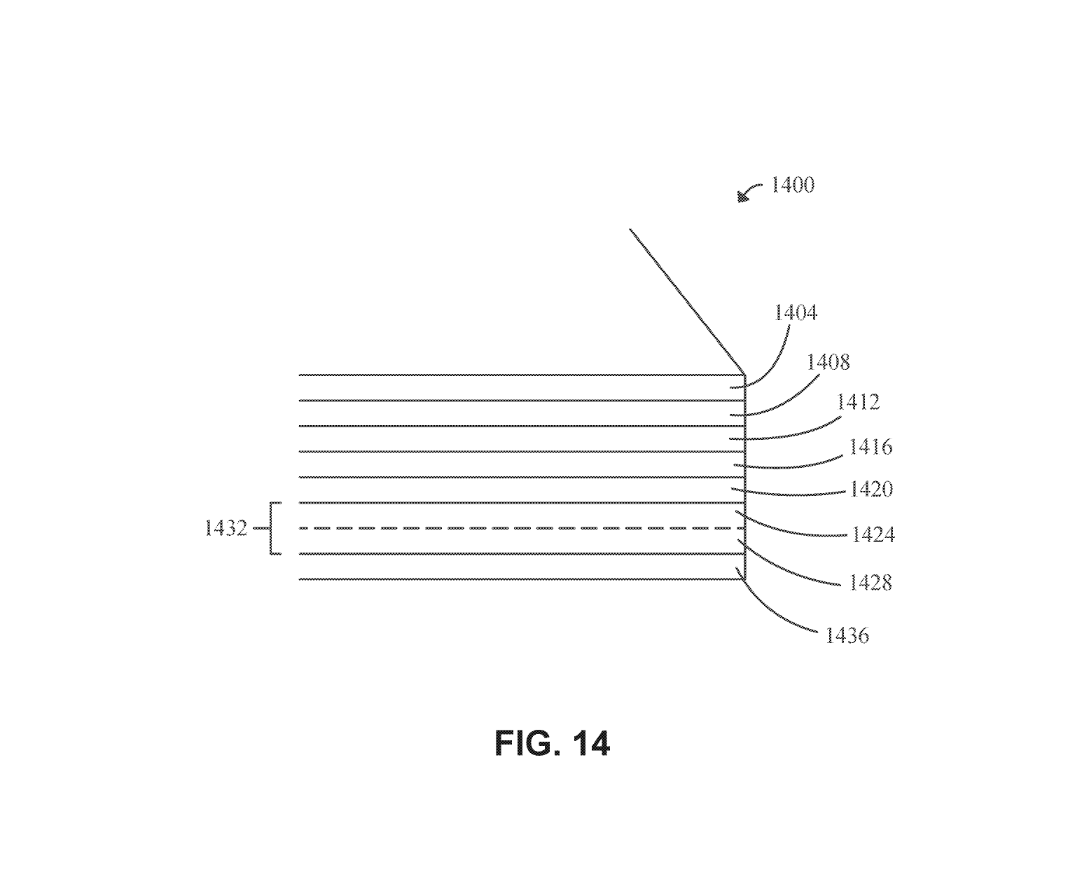

Referring now to FIG. 14, a side view of an exemplary embodiment of multi-layer sheet 1400 is depicted. Layers of FIG. 14 are not to scale and are only meant to show an exemplary embodiment of their relative positions. In some embodiments, higher layers in FIG. 14 are positioned closer to outside and/or first side of multi-layer sheet 1400, while lower layers in FIG. 14 are positioned closer to inside and/or second side of multi-layer sheet 1400. Multi-layer sheet 1400 may include first lubricant layer 1404, varnish layer 1408, printing ink layer 1412, primer layer 1416, aluminum layer 1420, tie layer 1424, and/or heat seal layer 1428. Tie layer 1424 and/or heat seal layer 1428 may be components of coextrusion coating 1432. Multi-layer sheet 1400 may further include second lubricant layer 1436. Multi-layer sheet may include multi-layer sheet characteristic as described in U.S. Nonprovisional Application No. 18/634,607, filed on April 12, 2024, and entitled “SINGLE USE CONTAINERS AND METHODS OF MANUFACTURING,” and having attorney docket no. 1326-006USU1.

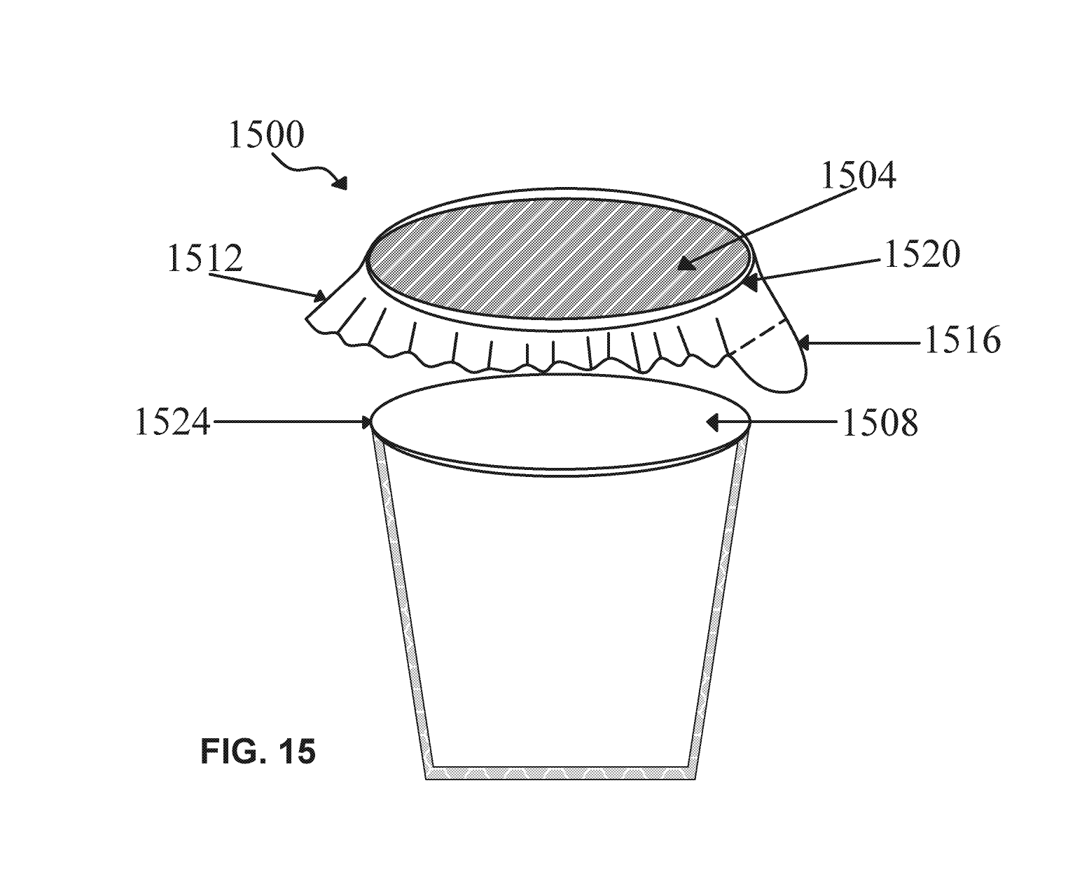

Now referring to FIG. 15, a nonlimiting particular embodiment of a container with a dual-layer lid 1500 structure is shown. In some embodiments, the container may include a dual-layer lid structure configured to enhance both sealing integrity and barrier performance. In some embodiments, the lid comprises a multi-layer structure comprising a metallic barrier layer disposed flat across the opening, wherein the lid further comprises a polymeric support layer folded around the bead. In this embodiment, the lid includes at least two distinct layers of material, each performing a specialized function during sealing. A first layer 1504, such as a metallic foil barrier (e.g., aluminum), may be disposed across the opening 1508 of the container body. This first layer remains substantially flat across the rim 1524 and provides a primary hermetic seal over the open end. The metallic foil layer may function as a gas and moisture barrier, preserving the freshness of the contents within the cavity of the container body. A second layer 1512, such as a polymer support layer, may be laminated to the foil layer or otherwise affixed thereto. This polymer support layer extends radially outward beyond the rim bead and is folded downward during sealing to conform around at least a portion of the bead. In this configuration, the foil layer provides sealing across the opening, while the polymer support layer provides additional mechanical retention by gripping the bead. The polymer support layer may also enhance flexibility at the fold line, reducing the risk of cracking or tearing in the metallic foil. The dual-layer configuration may offer several advantages. First, it allows the barrier layer to remain undisturbed across the container opening, maintaining its structural integrity and barrier properties. Second, it allows the fold-over portion to be carried primarily by the polymer support layer, which is engineered for flexibility and adhesion. Third, the configuration increases overall seal strength by combining horizontal hermetic sealing with vertical bead engagement, while minimizing material stress in the foil layer. In some embodiments, adhesives may be selectively applied to bond the foil to the top surface of the rim and to bond the polymer support layer to the bead. Heat sealing, ultrasonic welding, or pressure bonding may be used depending on the material composition. The polymer support layer may further include pre-creased or thinned fold lines to facilitate uniform bending around the bead. Variations of this embodiment may include additional layers, such as printable paper laminates for branding, or adhesive tie layers between the foil and polymer to optimize bonding. In some embodiments, the dual-layer lid may incorporate tamper-evident features, such as perforations in the polymer layer that break upon peeling while leaving the foil intact, or vice versa. Accordingly, the dual-layer lid with fold provides a synergistic design in which one layer ensures hermetic sealing across the opening and another layer provides mechanical locking around the bead, thereby combining the functional strengths of both materials while reducing their individual weaknesses. Accordingly, the partial wrap configuration enables a container closure that improves sealing performance compared to flat-sealed lids, while reducing the folding complexity, adhesive usage, and opening force associated with full wrap designs. This embodiment offers a practical balance of hermetic sealing, manufacturability, and consumer usability. In some embodiments, the dual-layer lid 1500 may include a folded lid with an integrated pull tab. In this configuration, the lid is sealed across the open end of the container body and folded downward around the bead of the rim 1524. Unlike conventional pull tabs that are separately attached or laminated, the pull tab in this embodiment is formed directly from the folded margin 1520 of the lid. The pull tab may be created by leaving a designated section of the folded margin unsealed against the bead during the folding process. This unsealed region may extend downward beyond the bead to form a flap that a user can grasp. Alternatively, the lid margin may be extended beyond the bead in a specific region, creating a downward-projecting tab integral with the folded portion. This approach integrates functionality into the closure geometry, eliminating the need for secondary pull-tab attachments and simplifying manufacturing. In some embodiments, the integrated pull tab may include reinforcement features to improve durability during opening. For example, the tab may include additional lamination layers, thicker polymer reinforcement, or embedded threads of paper, foil, or plastic. Such reinforcement prevents tearing or delamination when force is applied to initiate peeling. The integrated pull tab 1516 may also include perforations or frangible lines adjacent to the unsealed region, enabling the lid to separate cleanly from the bead when the tab is lifted. The integrated pull tab design offers multiple advantages. It provides a reliable grip point without requiring additional material or manufacturing steps, enhances tamper evidence (since the folded seal must be broken along both planes before access is gained), and maintains the aesthetic continuity of the bead-wrapping closure. In some embodiments, the pull tab may be recessed against the container wall, preventing accidental snagging, while in other embodiments it may be textured, embossed, or printed with indicia instructing the user on how to open the container. Accordingly, the folded lid with integrated pull tab 1516 combines sealing strength from the fold-over bead geometry with functional ease of access, resulting in a closure that is both robust and user-friendly. Container with a dual-layer lid may include container characteristics as described in U.S. Nonprovisional Application No. 19/377,203, filed on November 3, 2025, and entitled “CONTAINER WITH AN EDGE-WRAPPING CLOSURE AND A METHOD FOR SEALING A CONTAINER USING AN EDGE-WRAPPING CLOSURE,” and having attorney docket no. 1326-013USU1.

In an embodiment, the single use container may be molded using injection molding to create its precise shape and structure. In an embodiment, plastic pellets or granules may be heated to a molten state and injected into a pre-designed mold cavity to form the walls, base, and rim of the single-use container. The material may be food-grade plastic, such as polypropylene or similar polymers, chosen for its durability and heat-resistant properties. Once the plastic solidifies inside the mold, the single use container may be ejected and cooled to maintain its desired form. The injection molding process may incorporate multiple layers in the single use container’s structure, depending on functional requirements. For example, an oxygen barrier layer may be included to preserve the freshness of the single use container’s contents, which may be particularly useful when storing perishable products like coffee or powdered drinks. These layers may be bonded together during molding to ensure structural integrity and enhanced performance in sealing and protecting the single use container’s contents. Once the single use container is molded, it may undergo further refinement, such as trimming to smooth any excess plastic around its rim. This step may improve the single use container's compatibility with subsequent sealing processes. The rim may be designed to provide a secure surface for sealing, ensuring that it mates effectively with a lid or cover in future steps of production. The single use container may be filled with its intended product, such as ground coffee, tea leaves, or other consumables. During this stage, automated systems may measure the product with high precision to ensure uniformity across all containers. This filling process may occur in an environment controlled to limit exposure to oxygen and moisture, which could degrade the product's freshness. Before sealing, the single use container may be flushed with nitrogen gas to displace any residual oxygen inside the single use container. This step may help extend the product's shelf life by minimizing oxidation. Following nitrogen flushing, a foil or plastic film lid may be applied over the top of the single use container and aligned with its rim. The sealing process may involve heat sealing and pressure to create an airtight bond between the lid and the single use container’s rim. This bond may be critical in preventing leaks or contamination during storage and shipping. In certain embodiments, the lid may include perforations or a pre-designed structure to allow for easy puncture by brewing devices or other equipment designed to interact with the single use container. The sealed container may undergo quality assurance checks to confirm that it meets specified standards. These checks may include visual inspections for proper sealing, pressure tests to verify airtightness, and weight measurements to ensure correct product quantities. Containers failing quality control may be automatically flagged and removed from the production line for further evaluation. To enhance consumer convenience, the single use container may feature embossed or printed branding on its lid or body. This branding may include logos, instructions, or product identifiers and may be applied through automated processes like pad printing or laser marking. The labeling may use food-safe, durable inks to withstand storage and usage conditions. Without limitation, the completed containers may be packaged in boxes or cartons for shipping and retail sale. In some embodiments, additional environmental controls, such as nitrogen-filled packaging or vacuum sealing, may be used to further extend shelf life and ensure product integrity. The packaged containers may be optimized for stacking and shipping, designed to withstand mechanical stresses during transport.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

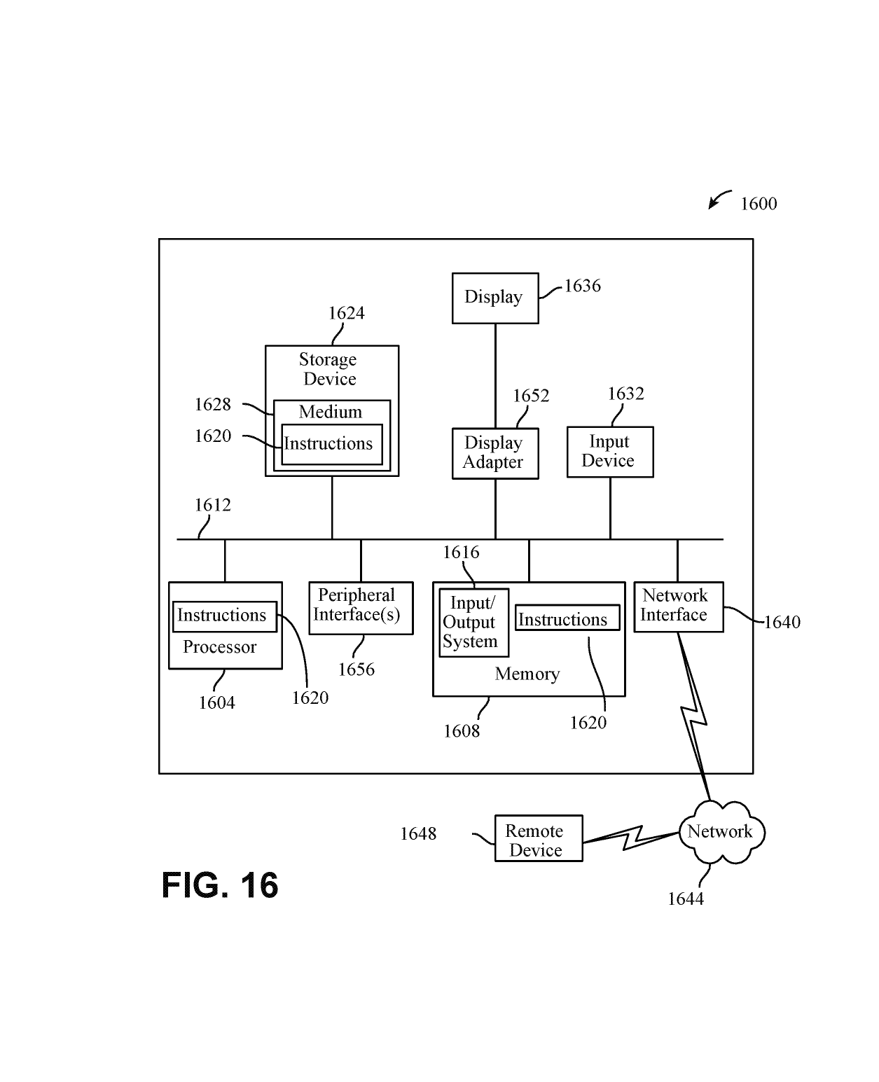

FIG. 16 shows a diagrammatic representation of one embodiment of computing device in the exemplary form of a computer system 1600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1600 includes a processor 1604 and a memory 1608 that communicate with each other, and with other components, via a bus 1612. Bus 1612 may include any of several types of bus structures including, but not limited to, a memory bus, a memory controller, a peripheral bus, a local bus, and any combinations thereof, using any of a variety of bus architectures.

Processor 1604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1604 may be organized according to Von Neumann and/or Harvard architecture as a non-limiting example. Processor 1604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 1608 may include various components (e.g., machine-readable media) including, but not limited to, a random-access memory component, a read only component, and any combinations thereof. In one example, a basic input/output system 1616 (BIOS), including basic routines that help to transfer information between elements within computer system 1600, such as during start-up, may be stored in memory 1608. Memory 1608 may also include (e.g., stored on one or more machine-readable media) instructions (e.g., software) 1620 embodying any one or more of the aspects and/or methodologies of the present disclosure. In another example, memory 1608 may further include any number of program modules including, but not limited to, an operating system, one or more application programs, other program modules, program data, and any combinations thereof.

Computer system 1600 may also include a storage device 1624. Examples of a storage device (e.g., storage device 1624) include, but are not limited to, a hard disk drive, a magnetic disk drive, an optical disc drive in combination with an optical medium, a solid-state memory device, and any combinations thereof. Storage device 1624 may be connected to bus 1612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1624 (or one or more components thereof) may be removably interfaced with computer system 1600 (e.g., via an external port connector (not shown)). Particularly, storage device 1624 and an associated machine-readable medium 1628 may provide nonvolatile and/or volatile storage of machine-readable instructions, data structures, program modules, and/or other data for computer system 1600. In one example, software 1620 may reside, completely or partially, within machine-readable medium 1628. In another example, software 1620 may reside, completely or partially, within processor 1604.

Computer system 1600 may also include an input device 1632. In one example, a user of computer system 1600 may enter commands and/or other information into computer system 1600 via input device 1632. Examples of an input device 1632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1632 may be interfaced to bus 1612 via any of a variety of interfaces (not shown) including, but not limited to, a serial interface, a parallel interface, a game port, a USB interface, a FIREWIRE interface, a direct interface to bus 1612, and any combinations thereof. Input device 1632 may include a touch screen interface that may be a part of or separate from display device 1636, discussed further below. Input device 1632 may be utilized as a user selection device for selecting one or more graphical representations in a graphical interface as described above.

A user may also input commands and/or other information to computer system 1600 via storage device 1624 (e.g., a removable disk drive, a flash drive, etc.) and/or network interface device 1640. A network interface device, such as network interface device 1640, may be utilized for connecting computer system 1600 to one or more of a variety of networks, such as network 1644, and one or more remote devices 1648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1644, may employ a wired and/or a wireless mode of communication. In general, any network topology may be used. Information (e.g., data, software 1620, etc.) may be communicated to and/or from computer system 1600 via network interface device 1640.

Computer system 1600 may further include a video display adapter 1652 for communicating a displayable image to a display device, such as display device 1636. Examples of a display device include, but are not limited to, a liquid crystal display (LCD), a cathode ray tube (CRT), a plasma display, a light emitting diode (LED) display, and any combinations thereof. Display adapter 1652 and display device 1636 may be utilized in combination with processor 1604 to provide graphical representations of aspects of the present disclosure. In addition to a display device, computer system 1600 may include one or more other peripheral output devices including, but not limited to, an audio speaker, a printer, and any combinations thereof. Such peripheral output devices may be connected to bus 1612 via a peripheral interface 1656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve devices and methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A single use container comprising:
a container body, wherein the container body comprises:
an open end;
a closed end;
a body wall between the open end and the closed end; and
at least an end lock feature disposed at or adjacent one of the open end and the closed end, wherein the end lock feature is configured to lock the single use container into a second container by engaging with a corresponding feature on the second container.

2. The single use container of claim 1, wherein the container body is constructed from a metal material.

3. The single use container of claim 1, wherein the container body comprises a coating material applied to the body wall.

4. The single use container of claim 1, wherein the at least an end lock feature comprise at least a top lock feature disposed at or adjacent the open end.

5. The single use container of claim 1, wherein the at least an end lock feature comprise at least a bottom lock feature disposed at or adjacent the closed end.

6. The single use container of claim 1, wherein the at least an end lock feature is configured to engage only upon application of a user applied axial force exceeding a predefined threshold.

7. The single use container of claim 1, wherein a stack height between two locked containers is between 5.3 mm and 6.3 mm.

8. The single use container of claim 1, wherein the open end includes a rim comprising a first raised rim and a second rim.

9. The single use container of claim 8, wherein the second rim comprises a layer configured to form a frangible seal with a lid.

10. The single use container of claim 1, wherein the at least an end lock feature and the corresponding feature form an interference-fit mechanism wherein:
the at least an end lock feature comprises a recess and the corresponding feature comprises a protrusion;
the recess is configured to align with the protrusion on the second container, and
the recess is configured to lock with the protrusion on the second container.

11. A single use container comprising:
a container body, wherein the container body comprises:
an open end;
a closed end;
a body wall between the open end and the closed end; and
at least a rotational engagement mechanism disposed at or adjacent the open end, wherein the at least a rotational engagement mechanism comprises:
an open configuration; and
a closed configuration, wherein the rotational engagement mechanism is configured to lock the single use container into a second container by engaging with a corresponding feature on the second container when the rotational engagement mechanism is rotated into the closed configuration.

12. The single use container of claim 11, wherein the container body is constructed from a metal material.

13. The single use container of claim 11, wherein the container body comprises a coating material applied to the body wall.

14. The single use container of claim 11, wherein the at least a rotational engagement mechanism comprises tabs and slots, wherein the tabs and slots are configured to interlock the single use container with a second container using rotational motion.

15. The single use container of claim 11, wherein the at least a rotational engagement mechanism comprises one or more alignment features.

16. The single use container of claim 15, wherein the one or more alignment featured comprise recesses disposed along the body wall.

17. A method of manufacturing a single use container, the method comprising:
fabricating a single use container by a printing process, wherein fabricating the single use container comprises:
generating, using at least a processor, a digital model of the single use container;
providing, using the at least a processor, the digital model to a three-dimensional (3D) printing apparatus; and
layering, using the 3D printing apparatus, printing material in accordance with the digital model.

18. The method of claim 17, wherein the printing material comprises a biocompatible polymer.

19. The method of claim 17, wherein the single use container comprises:
a container body, wherein the container body comprises:
an open end;
a closed end;
a body wall between the open end and the closed end; and
at least a locking feature, wherein the at least a locking feature is configured to lock the single use container into a second container by engaging with a corresponding feature on the second container.

20. The method of claim 17, wherein the at least a locking feature comprises one or more of a top lock feature, a bottom lock feature, and a rotational engagement mechanism.
